(19) United States
(12) Patent Application Publication
(10) Pub. No.: US 2020/0290156 A1
(43) Pub. Date: Sep. 17, 2020

(54) LASER PROCESSING METHOD AND LASER PROCESSING SYSTEM

(71) Applicant: Gigaphoton Inc., Tochigi (JP)

(72) Inventors: Akira SUWA, Oyama-shi (JP); Kouji KAKIZAKI, Oyama-shi (JP); Masakazu KOBAYASHI, Oyama-shi (JP); Osamu WAKABAYASHI, Oyama-shi (JP)

(73) Assignee: Gigaphoton Inc., Tochigi (JP)

(21) Appl. No.: 16/889,791

(22) Filed: Jun. 1, 2020

Related U.S. Application Data
(63) Continuation of application No. PCT/JP2018/002152, filed on Jan. 24, 2018.

(51) Int. Cl. B23K 26/382; B23K 26/0622; B23K 26/066; B23K 26/06; B23K 26/04; B23K 26/03

(52) U.S. Cl. CPC B23K 26/382; B23K 26/0622; B23K 26/066; B23K 2103/54; B23K 26/048; B23K 26/03; B23K 26/0665

(57) ABSTRACT

A laser processing method of performing laser processing on a transparent material that is transparent to ultraviolet light includes: A. a positioning step of performing positioning so that a transfer position of a transfer image is set at a position inside the transparent material at a predetermined depth ΔZsf from a surface of the transparent material in an optical axis direction; B. an irradiation condition acquisition step; C. a determination step of determining whether a maximum fluence of a pulse laser beam at the surface of the transparent material is within a predetermined range based on irradiation conditions; and D. a control step of allowing irradiation with the pulse laser beam when the maximum fluence is determined to be in the predetermined range.

### CROSS-REFERENCE TO RELATED APPLICATIONS

The present application is a continuation application of International Application No. PCT/JP2018/002152 filed on Jan. 24, 2018. The content of the application is incorporated herein by reference in its entirety.

### BACKGROUND

### 1. Technical Field

The present disclosure relates to a laser processing method and a laser processing system.

### 2. Related Art

Improvement of the resolution of a semiconductor exposure device has been requested along with miniaturization and high integration of a semiconductor integrated circuit. Hereinafter, the semiconductor exposure device is simply referred to as an “exposure device”. Thus, the wavelength of light output from an exposure light source has been shortened. A gas laser device is used as the exposure light source in place of a conventional mercury lamp. Currently used exposure gas laser devices are a KrF excimer laser device configured to output ultraviolet having a central wavelength of 248.4 nm approximately and an ArF excimer laser device configured to output ultraviolet having a central wavelength of 193.4 nm approximately.

The current exposure technology in practical use is, for example, liquid immersion exposure in which the gap between a projection lens on the exposure device side and a wafer is filled with liquid to change the refractive index of the gap so that the apparent wavelength of the exposure light source is shortened. When the liquid immersion exposure is performed by using the ArF excimer laser device as the exposure light source, the wafer is irradiated with ultraviolet light having a wavelength of 134 nm in the water. This technology is called ArF liquid immersion exposure. The ArF liquid immersion exposure is also called ArF liquid immersion lithography.

The KrF and ArF excimer laser devices each have a wide spectrum line width of 350 μm to 400 μm approximately due to spontaneous oscillation, and thus suffers chromatic aberration of a laser beam (ultraviolet light) projected on the wafer in a reduced size through the projection lens on the exposure device side, which leads to decrease of the resolution. To avoid this, the spectrum line width of a laser beam output from the gas laser device needs to be narrowed until the chromatic aberration becomes negligible. The spectrum line width is also called spectrum width. Thus, a line narrowing module including a line narrowing element is provided in a laser resonator of the gas laser device to achieve the spectrum width narrowing. The line narrowing element may be, for example, an etalon or a grating. A laser device having a narrowed spectrum width in this manner is referred to as a line narrowing laser device.

An excimer laser beam has a pulse width of 1 ns to 100 ns and a short central wavelength of 248.4 nm or 193.4 nm. With these characteristics, the excimer laser beam is sometimes used in direct processing of a polymer material, a glass material, and the like in addition to exposure usage. Bonding of a polymer material can be disconnected by the excimer laser beam having photon energy higher than the bond energy. Accordingly, non-heating processing is possible, and it is known that a clean processing shape is obtained. For example, glass and ceramics have high absorbance for the excimer laser beam, and thus it is known that materials difficult to process with visible and infrared laser beams can be processed with the excimer laser beam.

### LIST OF DOCUMENTS

### Patent Documents

Patent Document 1: International Patent Publication No. 2008/126742

Patent Document 2: U.S. Patent Publication No. 2015/0034613

Patent Document 3: Japanese Unexamined Patent Application Publication No. 4-111800

Patent Document 4: Japanese Unexamined Patent Application Publication No. 2005-066687

Patent Document 5: Japanese Unexamined Patent Application Publication No. 2003-119044

### SUMMARY

A laser processing method according to an aspect of the present disclosure performs laser processing on a transparent material that is transparent to ultraviolet light by using a laser processing system including a laser apparatus configured to output a pulse laser beam that is the ultraviolet light, a transfer mask provided with a transfer pattern through which the pulse laser beam passes, and a transfer optical system configured to transfer a transfer image formed when the pulse laser beam passes through the transfer pattern and having a shape in accordance with the transfer pattern, the laser processing method including:

A. a positioning step of performing relative positioning of a transfer position of the transfer image transferred by the transfer optical system and the transparent material in an optical axis direction of the pulse laser beam so that the transfer position is set at a position inside the transparent material at a predetermined depth ΔZsf from a surface of the transparent material in the optical axis direction;

B. an irradiation condition acquisition step of acquiring irradiation conditions including a target fluence of the pulse laser beam at the transfer position and the depth ΔZsf;

C. a determination step of determining whether a maximum fluence of the pulse laser beam at the surface of the transparent material is within a predetermined range based on the irradiation conditions; and

D. a control step of allowing irradiation with the pulse laser beam when the maximum fluence is determined to be in the predetermined range.

The target fluence is an average fluence in a beam section in a direction orthogonal to an optical axis of the pulse laser beam at the transfer position, and the maximum fluence is a maximum value among fluences of a plurality of small regions obtained by dividing the beam section on the surface of the transparent material.

A laser processing method according to another aspect of the present disclosure performs laser processing on a transparent material that is transparent to ultraviolet light by using a laser processing system including a laser apparatus configured to output a pulse laser beam that is the ultraviolet light and a condensation optical system configured to condense the pulse laser beam, the laser processing method including:

A. a positioning step of performing relative positioning of a beam waist position of the pulse laser beam and the transparent material in an optical axis direction of the pulse laser beam so that the beam waist position is set at a position inside the transparent material at a predetermined depth ΔZsfw from a surface of the transparent material in the optical axis direction;

B. an irradiation condition acquisition step of acquiring irradiation conditions including a target fluence of the pulse laser beam at the beam waist position and the depth ΔZsf;

C. a determination step of determining whether a maximum fluence of the pulse laser beam at the surface of the transparent material is within a predetermined range based on the irradiation conditions; and

D. a control step of allowing irradiation with the pulse laser beam when the maximum fluence is determined to be in the predetermined range.

The target fluence is an average fluence in a beam section in a direction orthogonal to an optical axis of the pulse laser beam at the beam waist position, and the maximum fluence is a maximum value among fluences of a plurality of small regions obtained by dividing the beam section on the surface of the transparent material.

A laser processing system according to another aspect of the present disclosure performs laser processing by irradiating a transparent material that is transparent to ultraviolet light with a pulse laser beam that is the ultraviolet light, and includes:

A. a laser apparatus configured to output a pulse laser beam;

B. a transfer mask provided with a transfer pattern through which the pulse laser beam output from the laser apparatus passes;

C. a transfer optical system configured to transfer, onto the transparent material, a transfer image formed when the pulse laser beam passes through the transfer pattern and having a shape in accordance with the transfer pattern;

D. a positioning mechanism configured to perform relative positioning of a transfer position of the transfer image transferred by the transfer optical system and the transparent material in an optical axis direction of the pulse laser beam so that the transfer position is set at a position inside the transparent material at a predetermined depth ΔZsf from a surface of the transparent material in the optical axis direction;

E. an irradiation condition acquisition unit configured to acquire irradiation conditions including a target fluence of the pulse laser beam at the transfer position and the depth ΔZsf;

F. a determination unit configured to determine whether a maximum fluence of the pulse laser beam at the surface of the transparent material is within a predetermined range based on the irradiation conditions; and

G. a control unit configured to allow irradiation with the pulse laser beam when the maximum fluence is determined to be in the predetermined range.

The target fluence is an average fluence in a beam section in a direction orthogonal to an optical axis of the pulse laser beam at the transfer position, and the maximum fluence is a maximum value among fluences of a plurality of small regions obtained by dividing the beam section on the surface of the transparent material.

### BRIEF DESCRIPTION OF THE DRAWINGS

Embodiments of the present disclosure will be described below as examples with reference to the accompanying drawings.

FIG. 1 schematically illustrates a configuration of a laser processing system of a comparative example.

FIGS. 2A and 2B are explanatory diagrams of a transfer position FP. FIG. 2A illustrates an example in which the transfer position FP is set on a surface of a workpiece, and FIG. 2B illustrates an example in which the transfer position FP is set at a position inside from the surface of the workpiece.

FIG. 3 is a flowchart illustrating a laser processing procedure of the comparative example.

FIG. 4 is a flowchart illustrating the processing procedure of laser processing of the comparative example.

FIGS. 5A to 5D are explanatory diagrams illustrating state transition of the workpiece when the laser processing in the first embodiment is provided. FIG. 5A illustrates a state of irradiation with the pulse laser beam while the transfer position of the pulse laser beam is adjusted to a position inside from a surface of the workpiece at a depth ΔZsf. FIG. 5B illustrates a processing state of the workpiece right after the pulse laser irradiation. FIG. 5C illustrates a self-focusing state of the pulse laser beam. FIG. 5D illustrates the processing state of the workpiece through the irradiation with the pulse laser beam.

FIG. 6 is an explanatory diagram of a crack CR generated in a hole H near the surface.

FIG. 7 is a picture obtained through image capturing of the crack CR.

FIG. 8 is an explanatory diagram of a top-hat beam profile.

FIG. 9 is an explanatory diagram of a Gaussian distribution beam profile.

FIG. 10 is an explanatory diagram of the fluence of a small region as a basis for calculation of a maximum fluence.

FIG. 11 is an explanatory diagram illustrating an aspect of focusing and divergence of light flux of a pulse laser beam by using a transfer optical system.

FIG. 12 is an explanatory diagram illustrating an aspect of light flux of the pulse laser beam when the transfer position FP is set inside a workpiece 41.

FIGS. 13A to 13E illustrate measurement data indicating the shape and light intensity distribution of a beam section SP at each distance ZL from the transfer position FP. FIG. 13A illustrates measurement data at a position at which the distance ZL is longest. FIG. 13E illustrates measurement data at the transfer position FP at which the distance ZL is “0”. FIGS. 13B to 13D each illustrate measurement data at the distance ZL between the distances for FIGS. 13A and 13E.

FIG. 14 is a graph illustrating correlation data of the distance ZL and a light intensity ratio R.

FIG. 15 is a first graph illustrating a relation between a target fluence Ft at the transfer position FP and a processing depth ΔZd.

FIG. 16 is a second graph obtained under a condition different from that for FIG. 15.

FIG. 17 is a picture illustrating a state of generation of the crack CR when processing is performed under conditions included in the graphs in FIGS. 15 and 16.

FIG. 18 is a third graph obtained under a condition different from that for FIG. 16.

FIG. 19 is a fourth graph obtained under a condition different from that for FIG. 18.

FIG. 20 is a picture illustrating a state of generation of the crack CR when processing is performed under conditions included in the graphs in FIGS. 19 and 18.

FIG. 21 is a table listing experiment results illustrated in FIGS. 15 to 20.

FIG. 22 schematically illustrates a configuration of a laser processing system of a first embodiment.

FIG. 23 is a flowchart illustrating a laser processing procedure of the first embodiment.

FIG. 24 is a flowchart illustrating a procedure for evaluating a maximum fluence of the first embodiment.

FIG. 25 is a graph illustrating a relation between an irradiation pulse number N and the processing depth ΔZd.

FIG. 26 schematically illustrates a configuration of a laser processing system of a second embodiment.

FIG. 27 is an explanatory diagram illustrating an aspect of the pulse laser beam when a condensation optical system is used.

FIG. 28 is an explanatory diagram of beam profiles at a beam waist position and the surface of the workpiece.

FIG. 29 is a graph illustrating correlation data of a distance ZLw and a light intensity ratio R of the second embodiment.

FIG. 30 is a flowchart illustrating a laser processing procedure of the second embodiment.

FIG. 31 is a flowchart illustrating a procedure for evaluating a maximum fluence of the second embodiment.

FIG. 32 is a flowchart illustrating the processing procedure of laser processing.

FIG. 33 schematically illustrates a configuration of a laser processing system of a third embodiment.

FIG. 34 is a flowchart illustrating a procedure for acquiring correlation data.

FIG. 35 is a flowchart illustrating a procedure for calculating a maximum light intensity and an average light intensity.

FIG. 36 is a flowchart illustrating the procedure for calculating the maximum light intensity.

FIG. 37 illustrates a first modification of a laser processing device.

FIG. 38 illustrates a second modification of the laser processing device.

FIG. 39 illustrates a first modification of a laser apparatus.

FIG. 40 illustrates a second modification of the laser apparatus.

### DESCRIPTION OF EMBODIMENTS

<Contents>
1. Overview
2. Laser processing system and laser processing method according to comparative example
   2.1 Configuration
      2.1.1 Entire configuration
      2.1.2 Depth ΔZsf of transfer position
   2.2 Operation
      2.2.1 Mechanism for estimating hole processing at high aspect ratio
   2.3 Problem
3. Crack generation factor analysis
4. Laser processing system and laser processing method of first embodiment
   4.1 Configuration
   4.2 Operation
   4.3 Effect
   4.4 Preferable processing conditions
      4.4.1 Pulse width of pulse laser beam
      4.4.2 Range of beam diameter Di
      4.4.3 Preferable conditions when workpiece 41 is synthetic quartz glass
         4.4.3.1 Wavelength of pulse laser beam
         4.4.3.2 Range of depth ΔZsf
         4.4.3.3 Range of target fluence Ft
         4.4.3.4 Allowable range of maximum fluence Fsfp
         4.4.3.5 Range of irradiation pulse number N
   4.5 Other
5. Laser processing system and laser processing method of second embodiment
   5.1 Configuration
   5.2 Operation
   5.3 Effect
   5.4 Other
6. Laser processing system and laser processing method of third embodiment
   6.1 Configuration
   6.2 Operation
   6.3 Effect
   6.4 Other
7. Modifications of laser processing device
   7.1 Modification 7-1
   7.2 Modification 7-2
8. Modifications of laser apparatus
   8.1 Modification 8-1
   8.2 Modification 8-2

Embodiments of the present disclosure will be described below in detail with reference to the accompanying drawings. The embodiments described below are examples of the present disclosure, and do not limit the contents of the present disclosure. Not all configurations and operations described in each embodiment are necessarily essential as configurations and operations of the present disclosure. Components identical to each other are denoted by an identical reference sign, and duplicate description thereof will be omitted.

1. Overview

The present disclosure relates to a laser processing system and a laser processing method that perform laser processing by irradiating a workpiece with a laser beam.

2. Laser Processing System and Laser Processing Method According to Comparative Example

2.1 Configuration

2.1.1 Entire configuration

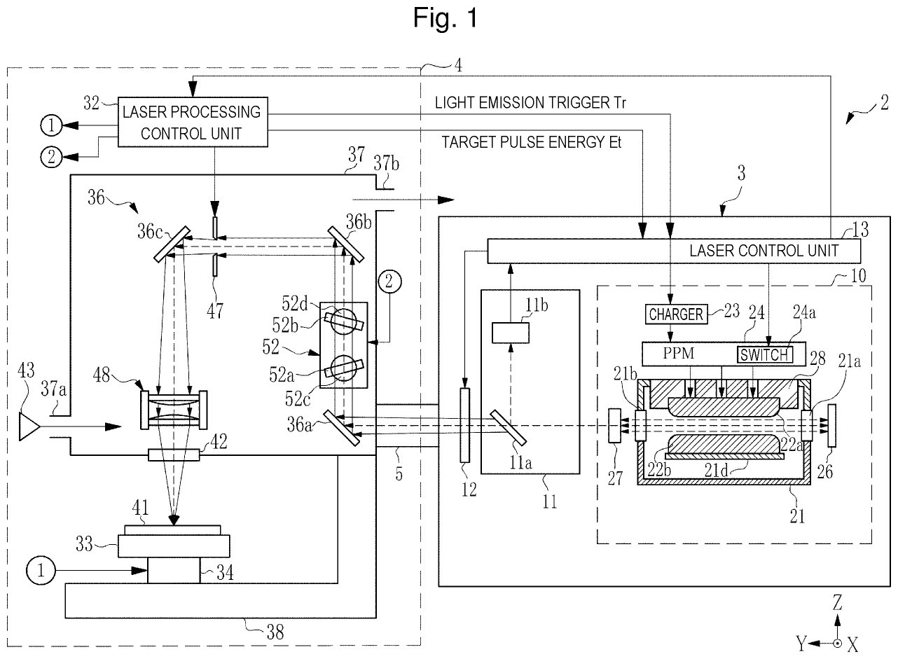

FIG. 1 schematically illustrates a configuration of a laser processing system according to a comparative example. This laser processing system 2 includes a laser apparatus 3 and a laser processing device 4. The laser apparatus 3 and the laser processing device 4 are connected with each other through an optical path pipe 5.

The laser apparatus 3 includes a master oscillator 10, a monitor module 11, a shutter 12, and a laser control unit 13. The laser apparatus 3 is an ArF excimer laser apparatus configured to use, as a laser medium, ArF laser gas containing argon (Ar) and fluorine (F). The laser apparatus 3 outputs an ultraviolet pulse laser beam that is an ArF laser beam having a central wavelength of 193.4 nm approximately.

The master oscillator 10 includes a laser chamber 21, a pair of electrodes 22a and 22b, a charger 23, and a pulse power module (PPM) 24. FIG. 1 illustrates an internal configuration of the laser chamber 21 in a direction substantially orthogonal to a traveling direction of a laser beam.

The laser chamber 21 encapsulates the ArF laser gas. The electrodes 22a and 22b are disposed in the laser chamber 21 as electrodes for exciting the laser medium by electric discharge.

An opening is formed in the laser chamber 21 and blocked by an electric insulating member 28. The electrode 22a is supported by the electric insulating member 28, and the electrode 22b is supported by a return plate 21d. The return plate 21d is connected with an inner surface of the laser chamber 21 through a wire (not illustrated). A conductive member is embedded in the electric insulating member 28. The conductive member applies, to the electrode 22a, a high voltage supplied from the pulse power module 24.

The charger 23 is a direct-current power supply device configured to charge a charging capacitor (not illustrated) in the pulse power module 24 at a predetermined voltage. The pulse power module 24 includes a switch 24a controlled by the laser control unit 13. When the switch 24a being off is turned on, the pulse power module 24 generates a pulse high voltage from electric energy held at the charger 23, and applies the high voltage between the electrodes 22a and 22b.

When the high voltage is applied between the electrodes 22a and 22b, insulation between the electrodes 22a and 22b is broken, and electric discharge occurs. The laser medium in the laser chamber 21 is excited by the energy of the electric discharge and transitions to a high energy level. Thereafter, as the excited laser medium transitions to a low energy level, light is emitted in accordance with the difference between the energy levels.

Windows 21a and 21b are provided at both ends of the laser chamber 21. Light generated in the laser chamber 21 is emitted out of the laser chamber 21 through the windows 21a and 21b.

The master oscillator 10 further includes a rear mirror 26 and an output coupling mirror 27. The rear mirror 26 is coated with a high reflection film, and the output coupling mirror 27 is coated with a partial reflection film. The rear mirror 26 reflects, at high reflectance, light emitted through the window 21a of the laser chamber 21, and returns the light to the laser chamber 21. The output coupling mirror 27 transmits and outputs part of light output through the window 21b of the laser chamber 21, and reflects the other part back into the laser chamber 21.

Thus, the rear mirror 26 and the output coupling mirror 27 constitute an optical resonator. The laser chamber 21 is disposed on the optical path of the optical resonator. While traveling forward and backward between the rear mirror 26 and the output coupling mirror 27, light emitted from the laser chamber 21 is amplified each time the light passes through a laser gain space between the electrodes 22a and 22b. Part of the amplified light is output as a pulse laser beam through the output coupling mirror 27.

The monitor module 11 is disposed on the optical path of the pulse laser beam emitted from the master oscillator 10. The monitor module 11 includes, for example, a beam splitter 11a and an optical sensor 11b.

The beam splitter 11a transmits, toward the shutter 12 at high transmittance, the pulse laser beam emitted from the master oscillator 10, and reflects part of the pulse laser beam toward a light receiving surface of the optical sensor 11b. The optical sensor 11b detects the pulse energy of the pulse laser beam incident on the light receiving surface, and outputs data of the detected pulse energy to the laser control unit 13.

The laser control unit 13 communicates various signals with a laser processing control unit 32. For example, the laser control unit 13 receives data of a light emission trigger Tr and a target pulse energy Et from the laser processing control unit 32. The laser control unit 13 transmits a setting signal for a charge voltage to the charger 23, and transmits a command signal for turning on or off the switch 24a to the pulse power module 24.

The laser control unit 13 receives the pulse energy data from the monitor module 11, and controls the charge voltage of the charger 23 with reference to the received pulse energy data. The pulse energy of the pulse laser beam is controlled through the control of the charge voltage of the charger 23.

The shutter 12 is disposed on the optical path of the pulse laser beam having passed through the beam splitter 11a of the monitor module 11. The laser control unit 13 controls the shutter 12 to close until the difference between the pulse energy received from the monitor module 11 and the target pulse energy Et becomes within an allowable range after start of laser oscillation. When the difference between the pulse energy received from the monitor module 11 and the target pulse energy Et becomes within the allowable range, the laser control unit 13 controls the shutter 12 to open. The laser control unit 13 transmits, in synchronization with a signal for opening the shutter 12, a signal indicating that it has become possible to receive the light emission trigger Tr of the pulse laser beam to the laser processing control unit 32 of the laser processing device 4.

The laser processing device 4 includes the laser processing control unit 32, a table 33, an XYZ stage 34, an optical system 36, a housing 37, and a frame 38. The optical system 36 is disposed in the housing 37. The housing 37 and the XYZ stage 34 are fixed to the frame 38.

The table 33 supports a workpiece 41. The workpiece 41 is a processing target to be irradiated with the pulse laser beam and subjected to laser processing. The workpiece 41 is a transparent material that is transparent to an ultraviolet pulse laser beam, and is, for example, synthetic quartz glass. The laser processing is, for example, hole processing that produces a hole in the workpiece 41. The XYZ stage 34 supports the table 33. The XYZ stage 34 is movable in an X-axis direction, a Y-axis direction, and a Z-axis direction, and the position of the workpiece 41 can be adjusted by adjusting the position of the table 33. The XYZ stage 34 adjusts the position of the workpiece 41 under control of the laser processing control unit 32 so that the pulse laser beam emitted from the optical system 36 is incident on a desired processing place.

For example, the laser processing system 2 performs hole processing at one position or a plurality of positions on the workpiece 41. Position data in accordance with a plurality of processing places is sequentially set to the laser processing control unit 32. The position data of each processing place is, for example, coordinate data that defines the positions of the processing place in the X-axis direction, the Y-axis direction, and the Z-axis direction with respect to the origin of the XYZ stage 34. The laser processing control unit 32 performs positioning of the workpiece 41 on the XYZ stage 34 by controlling a moving amount of the XYZ stage 34 based on the coordinate data.

The optical system 36 includes, for example, high reflectance mirrors 36a to 36c, a transfer mask 47, and a transfer lens 48, and transfers an image corresponding to a processing shape onto the surface of the workpiece 41. The high reflectance mirrors 36a to 36c, the transfer mask 47, and the transfer lens 48 are each fixed to a holder (not illustrated) and disposed at a predetermined position in the housing 37.

The high reflectance mirrors 36a to 36c each reflect the pulse laser beam in the ultraviolet region at high reflectance. The high reflectance mirror 36a reflects, toward the high reflectance mirror 36b, the pulse laser beam input from the laser apparatus 3, and the high reflectance mirror 36b reflects the pulse laser beam toward the high reflectance mirror 36c. The high reflectance mirror 36c reflects the pulse laser beam toward the transfer lens 48. In the high reflectance mirrors 36a to 36c, for example, a surface of a transparent substrate made of synthetic quartz or calcium fluoride is coated with a reflective film that highly reflects the pulse laser beam.

The transfer mask 47 is disposed on an optical path between the high reflectance mirrors 36b and 36c. The transfer mask 47 forms the image of the pulse laser beam corresponding to the processing shape to be transferred onto the workpiece 41 by allowing part of the pulse laser beam reflected by the high reflectance mirror 36b to pass therethrough. For example, the transfer mask 47 is obtained by forming, on a light-shielding plate having a light-shielding property for shielding the pulse laser beam, a transfer pattern configured by a transmission hole through which light passes. Hereinafter, the image of the pulse laser beam that is formed in accordance with the shape of the transfer pattern of the transfer mask 47 is referred to as a transfer image.

In the present example, the transfer pattern of the transfer mask 47 is a circular pinhole. By using such a transfer mask 47, the laser processing device 4 of the present example performs, on the workpiece 41, hole processing that forms a hole having a circular section. The transfer mask 47 includes a change mechanism capable of changing a size of the pinhole, and can adjust the size of the pinhole in accordance with a dimension of processing on the workpiece 41. The laser processing control unit 32 adjusts the size of the pinhole by controlling the change mechanism of the transfer mask 47.

The transfer lens 48 condenses the pulse laser beam incident thereon, and emits the condensed pulse laser beam toward the workpiece 41 through a window 42. The transfer lens 48 constitutes a transfer optical system through which the transfer image generated as the pulse laser beam passes through the transfer mask 47 and having the shape of the pinhole is imaged at a position in accordance with the focal length of the transfer lens 48. Hereinafter, the imaging position at which the transfer image is imaged by the effect of the transfer lens 48 is referred to as a transfer position.

The position of the transfer position in the Z-axis direction is set, based on irradiation conditions acquired in advance, at a predetermined position with respect to a surface on the incident side on which the pulse laser beam is incident. Positioning of the transfer position in the Z-axis direction corresponds to positioning in the optical axis direction of the pulse laser beam. The positioning of the transfer position will be described later. Hereinafter, the surface of the workpiece 41 means the surface of the workpiece 41 on the incident side unless otherwise stated. The Z-axis direction is parallel to the optical axis direction of the pulse laser beam emitted from the transfer lens 48 and incident on the workpiece 41.

The transfer lens 48 is configured as a combination of a plurality of lenses. The transfer lens 48 is a reduction optical system through which the transfer image in the pinhole shape having a dimension smaller than the actual dimension of the pinhole provided to the transfer mask 47 is imaged on the transfer position. The transfer optical system constituted by the transfer lens 48 has, for example, a magnification M of 1/10 to ⅕. The transfer lens 48 is a combination lens in the present example, but may be configured as a single lens when one small circular transfer image is imaged near the optical axis of the transfer lens 48.

The window 42 is disposed on the optical path between the transfer lens 48 and the workpiece 41, and fixed to an opening formed in the housing 37 while being sealed by an O ring (not illustrated).

An attenuator 52 is disposed on the optical path between the high reflectance mirror 36a and the high reflectance mirror 36b in the housing 37. The attenuator 52 includes, for example, two partially reflective mirrors 52a and 52b, and rotation stages 52c and 52d of these partially reflective mirrors. The two partially reflective mirrors 52a and 52b are optical elements, the transmittance of each of which changes in accordance with the incident angle of the pulse laser beam. The tilt angles of the partially reflective mirrors 52a and 52b are adjusted by the rotation stages 52c and 52d so that the incident angle of the pulse laser beam is equal therebetween and desired transmittance is obtained.

Accordingly, the pulse laser beam is dimmed to desired pulse energy and passes through the attenuator 52. Transmittance T of the attenuator 52 is controlled based on a control signal from the laser processing control unit 32. In addition to control of the fluence of the pulse laser beam output from the laser apparatus 3 through the target pulse energy Et, the laser processing control unit 32 controls the fluence of the pulse laser beam through control of the transmittance T of the attenuator 52. The fluence can be changed by changing the target pulse energy Et, but it is difficult to largely change the pulse energy at the master oscillator 10 of the laser apparatus 3. The fluence can be changed by using the attenuator 52 even when output from the master oscillator 10 is constant.

Nitrogen (N₂) gas, which is inert gas, always flows inside the housing 37 while the laser processing system 2 is in operation. The housing 37 is provided with an intake port 37a through which the nitrogen gas is taken into the housing 37, and a discharge port 37b through which the nitrogen gas is externally discharged from the housing 37. The intake port 37a and the discharge port 37b can be connected with an intake pipe and a discharge pipe (not illustrated). When connected with the intake pipe and the discharge pipe, the intake port 37a and the discharge port 37b are each sealed by an O ring (not illustrated) to prevent mixture of outside air into the housing 37. The intake port 37a is connected with a nitrogen gas supply source 43. The optical path in the laser apparatus 3 is sealed and purged by nitrogen gas that is inert gas.

The nitrogen gas also flows inside the optical path pipe 5. The optical path pipe 5 is sealed by O rings at a connection part with the laser processing device 4 and at a connection part with the laser apparatus 3.

2.1.2 Depth ΔZsf of Transfer Position

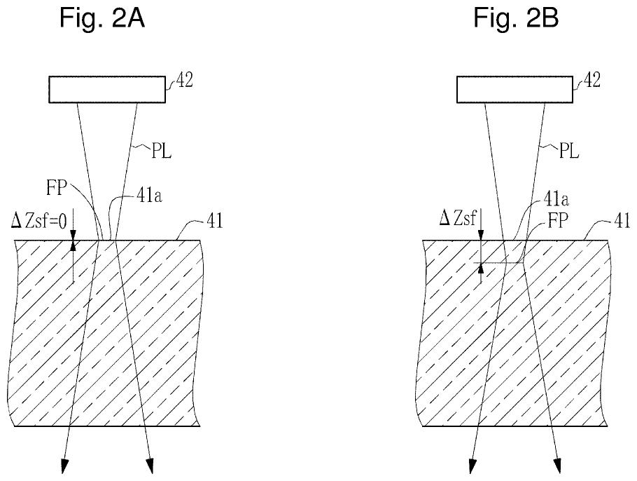

As illustrated in FIGS. 2A and 2B, the laser processing control unit 32 performs relative positioning of a transfer position FP of a pulse laser beam PL and the workpiece 41 in the Z-axis direction with reference to a surface 41a of the workpiece 41. Specifically, the laser processing control unit 32 performs the positioning so that the transfer position FP is set at a position inside the workpiece 41 at a predetermined depth ΔZsf from the surface 41a of the workpiece 41 in the optical axis direction. The depth ΔZsf is input as an irradiation condition. The laser processing control unit 32 performs the positioning of the transfer position FP and the workpiece 41 in the Z-axis direction by controlling the XYZ stage 34 in accordance with the value of the depth ΔZsf.

As illustrated in FIG. 2A, when the value of the depth ΔZsf is 0 mm, the transfer position FP is set at the position of the surface 41a. In this case, the transfer position FP coincides with the surface 41a of the workpiece 41 in the Z-axis direction. As illustrated in FIG. 2B, when the value of ΔZsf is larger than zero, for example, 1 mm, the transfer position FP is set at the position inside from the surface 41a at the depth ΔZsf in accordance with the value. The laser processing control unit 32 corresponds to a positioning control unit configured to perform the relative positioning of the transfer position FP and the workpiece 41 in the optical axis direction of the pulse laser beam by controlling the XYZ stage 34 as a positioning mechanism.

2.2 Operation

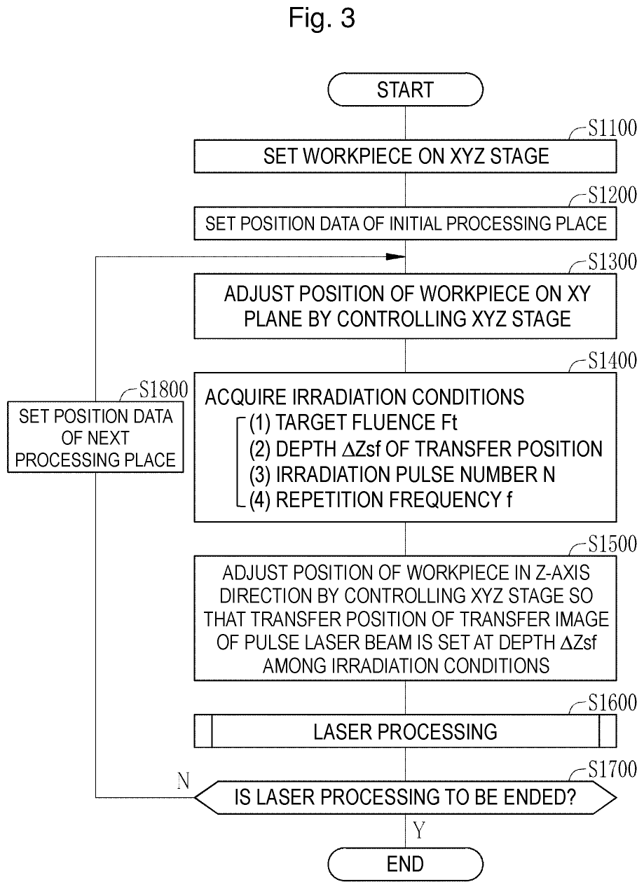

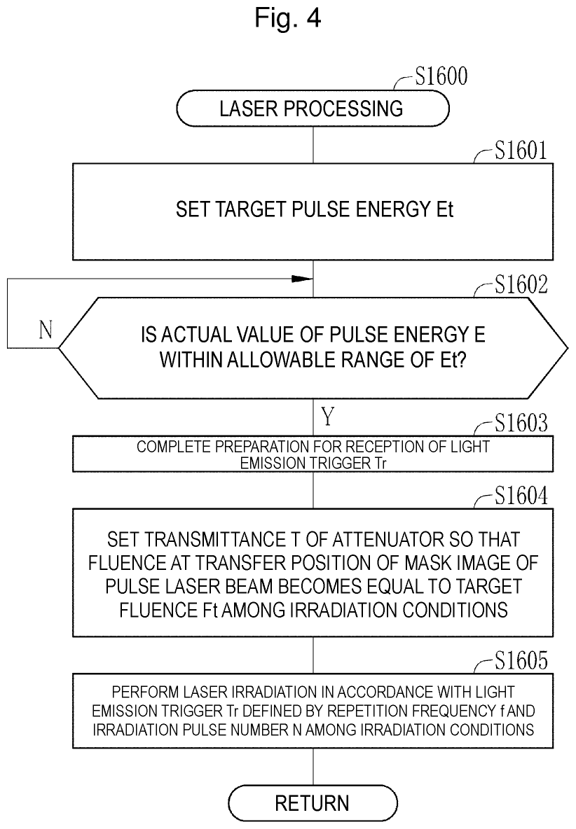

The following describes the operation of the laser processing system 2 with reference to FIGS. 3 and 4. As illustrated in FIG. 3, when the laser processing is performed, the workpiece 41 is set on the table 33 of the XYZ stage 34 (S1100). The laser processing control unit 32 sets position data of an initial processing place to the XYZ stage 34 (S1200).

The laser processing control unit 32 adjusts the position of the workpiece 41 on the XY plane by controlling the XYZ stage 34 (S1300). At S1300, the laser processing control unit 32 adjusts the position of the workpiece 41 on the XY plane by controlling the moving amount of the XYZ stage 34 based on coordinate data on the XY plane included in the position data. Accordingly, the position of the workpiece 41 on the XY plane is set.

The laser processing control unit 32 acquires irradiation conditions of the pulse laser beam PL (S1400). Data of the irradiation conditions is, for example, manually input through an operation by an operator on an operation panel or the like and stored in a memory in the laser processing control unit 32 or an external data storage. The laser processing control unit 32 acquires the irradiation conditions by reading the data of the irradiation conditions from the memory or the data storage. The irradiation conditions include a target fluence Ft at the transfer position FP, the depth ΔZsf of the transfer position FP, an irradiation pulse number N of the pulse laser beam to be emitted, and a repetition frequency f of the pulse laser beam. Among the irradiation conditions, the depth ΔZsf is included in the position data set at S1200.

Subsequently, the laser processing control unit 32 adjusts the position of the workpiece 41 in the Z-axis direction by controlling the XYZ stage 34 so that the transfer position FP of the transfer image of the pulse laser beam PL is set at the depth ΔZsf among the irradiation conditions (S1500).

In the present example, the transfer position FP is determined in accordance with the distance between the transfer mask 47 and the transfer lens 48, the focal length of the transfer lens 48, and the like. Thus, at S1500, the laser processing control unit 32 performs relative positioning of the transfer position FP of the transfer image of the pulse laser beam PL and the surface 41a of the workpiece 41 in the Z-axis direction by controlling the moving amount of the XYZ stage 34. Since the Z-axis direction is parallel to the optical axis direction of the pulse laser beam incident on the workpiece 41 as described above, the positioning in the Z-axis direction corresponds to positioning in the optical axis direction of the pulse laser beam.

When the positioning of the workpiece 41 ends, laser processing is performed (S1600). When a next processing position exists (N at S1700) after the laser processing on the initial processing position has ended, the laser processing control unit 32 sets position data of the next processing position to the XYZ stage 34 (S1800). Then, the laser processing control unit 32 performs movement of the workpiece 41 to the next processing position and acquisition of the irradiation conditions (S1300 to S1500). At the next processing position, the laser processing is performed on the workpiece 41 (S1600). When the next processing position does not exist, the laser processing ends (Y at S1700). Such a procedure is repeated until the laser processing on all processing positions ends.

In the present example, the position on the XY plane and the position in the Z-axis direction are both adjusted for each processing position. In addition, the irradiation conditions are acquired for each processing position. However, when the position in the Z-axis direction and the irradiation conditions are same among a plurality of processing positions, the processing may be performed as follows.

Specifically, after step S1400 of acquiring the irradiation conditions and step S1500 of adjusting the position in the Z-axis direction are performed at the initial processing position, steps S1400 and S1500 may be omitted for the following processing positions. In this case, for example, step S1400 of acquiring the irradiation conditions and step S1500 of adjusting the position in the Z-axis direction are first performed after step S1200 of setting position data of the initial processing position. Thereafter, step S1300 is performed to adjust the position on the XY plane for the initial processing position, and step S1600 is performed. Then, after step S1800 is performed for the next processing position, only step S1300 is performed without performing steps S1400 and S1500, and step S1600 is performed.

The laser processing at S1600 in FIG. 3 is performed in accordance with a flowchart illustrated in FIG. 4. The laser processing control unit 32 transmits the target pulse energy Et to the laser control unit 13 of the laser apparatus 3. Accordingly, the target pulse energy Et is set at the laser control unit 13 (S1601).

When having received the target pulse energy Et from the laser processing control unit 32, the laser control unit 13 closes the shutter 12 and actuates the charger 23. Then, the laser control unit 13 turns on the switch 24a of the pulse power module 24 by an internal trigger (not illustrated). Accordingly, the master oscillator 10 performs laser oscillation.

The monitor module 11 samples the pulse laser beam output from the master oscillator 10 to measure pulse energy E as an actual value of the pulse energy. The laser control unit 13 controls the charge voltage of the charger 23 so that a difference ΔE between the pulse energy E and the target pulse energy Et approaches to zero. Specifically, the laser control unit 13 controls the charge voltage so that the difference ΔE becomes within an allowable range.

The laser control unit 13 monitors whether the difference ΔE has become within the allowable range (S1602). When the difference ΔE has become within the allowable range (Y at S1602), the laser control unit 13 transmits, to the laser processing control unit 32, a reception preparation completion signal notifying completion of preparation for reception of the light emission trigger Tr, and opens the shutter 12. Accordingly, the laser apparatus 3 completes the preparation for reception of the light emission trigger Tr (S1603).

Having received the reception preparation completion signal, the laser processing control unit 32 sets the transmittance T of the attenuator 52 so that the fluence at the transfer position FP of the transfer image of the pulse laser beam becomes equal to the target fluence Ft defined among the irradiation conditions (S1604).

When the optical system 36 has no light loss, a fluence F at the transfer position FP is obtained from Expression (1) below.

F=(Et/Tsl)·T/{π(Di/2)z} (1)

In the above expression, T represents the transmittance of the attenuator 52, Et represents the pulse energy of the pulse laser beam output from the laser apparatus, Tsl represents the transmittance of the pulse laser beam for the transfer mask 47, and Di represents the diameter of the transfer image. In other words, the diameter Di is the diameter of a beam section orthogonal to the optical axis direction of the pulse laser beam at the transfer position.

When the optical system 36 has no light loss, the transmittance T of the attenuator 52 is obtained by Expression (2) below from Expression (1).

T=π(Di/2)²·F/(Et·Tsl) (2)

Expression (2) is obtained when it is assumed that the optical system 36 has no light loss, for example, the high reflectance mirrors 36a to 36c, the transfer lens 48, and the window 42 each have a transmittance of 100%. To take the light loss of the optical system 36 into consideration, calculation may be performed as in Expression (3) below by using a transmittance ISO of the optical system 36.

T=π(Di/2)²·F/(Et·Tsl·TS0) (3)

After having set the transmittance T of the attenuator 52, the laser processing control unit 32 transmits the light emission trigger Tr defined by the predetermined repetition frequency f and the predetermined irradiation pulse number N to the laser control unit 13. As a result, in synchronization with the light emission trigger Tr, the pulse laser beam having passed through the beam splitter 11a of the monitor module 11 is output from the laser apparatus 3 and incident on the laser processing device 4.

The pulse laser beam incident on the laser processing device 4 is dimmed at the attenuator 52 via the high reflectance mirror 36a. The pulse laser beam having passed through the attenuator 52 is reflected at the high reflectance mirror 36b and incident on the transfer mask 47.

In the pulse laser beam incident on the transfer mask 47, the pulse laser beam having passed through the pinhole is reflected at the high reflectance mirror 36c and incident on the transfer lens 48. The pulse laser beam having passed through the pinhole of the transfer mask 47 is incident on the transfer lens 48. The transfer image of the pinhole of the transfer mask 47, which is reduced in size is transferred to the position of the depth ΔZsf on the surface of the workpiece 41 through the window 42 by the transfer lens 48. The pulse laser beam having passed through the transfer lens 48 is incident on a region on and inside the surface of the workpiece 41 corresponding to the transfer image. This laser irradiation with the pulse laser beam is performed in accordance with the light emission trigger Tr defined by the repetition frequency f and the irradiation pulse number N necessary for the laser processing (S1605). Through the laser irradiation, the laser processing of forming a hole in the pinhole shape is performed on the workpiece 41.

2.2.1 Mechanism for Estimating Hole Processing at High Aspect Ratio

It has been known that a hole having a high aspect ratio is formed through such laser processing of forming a hole in the workpiece 41. The hole having a high aspect ratio means an elongated hole in which a processing depth as the depth of the hole is large relative to the diameter of the hole. Specifically, the hole having a high aspect ratio is, for example, a hole in which the diameter of the hole is 10 μm to 150 μm approximately and the processing depth is 1.0 mm (1000 μm) approximately or larger. Here, the high aspect ratio is defined to be 1000 μm/100 μm=10 or larger.

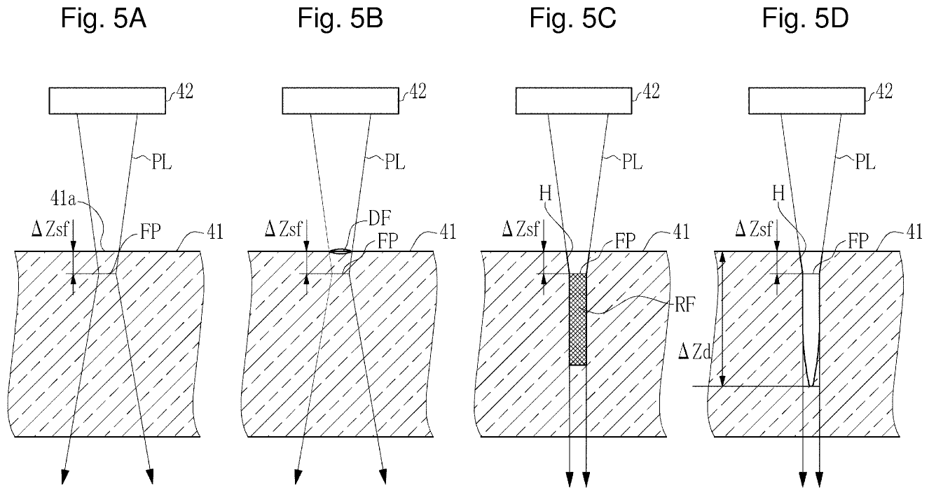

FIGS. 5A to 5D are explanatory diagrams illustrating state transition of the workpiece 41 when the laser processing is performed on the workpiece 41 by using the laser processing system 2 and a laser processing method of the comparative example. In FIGS. 5A to 5D, the depth ΔZsf is, for example, 1 mm, and FIGS. 5A to 5D illustrate an example in which the positioning is performed so that the transfer position FP of the transfer image of the pulse laser beam PL is set at a position inside from the surface 41a of the workpiece 41 at 1 mm as illustrated in FIG. 5A. Laser irradiation is performed in this state, and the pulse laser beam PL having passed through the window 42 is incident on the workpiece 41.

Since the pulse laser beam PL is an ArF laser beam having a central wavelength of 193.4 nm approximately and the workpiece 41 is synthetic quartz glass that is transparent to an ArF laser beam, the pulse laser beam PL passes through the workpiece 41 right after irradiation as illustrated in FIG. 5A. As the irradiation with the pulse laser beam PL continues, a defect DF occurs near the surface of the workpiece 41 as illustrated in FIG. 5B, and absorption of the pulse laser beam PL starts.

As the irradiation with the pulse laser beam continues, the rate of absorption of the pulse laser beam increases near the surface 41a of the workpiece 41 where the absorption of the pulse laser beam PL starts, and ablation processing starts as illustrated in FIG. 5B. After the start of the ablation processing, part of the pulse laser beam is not absorbed but passes through the inside of the workpiece 41. At a certain timing after the start of the ablation processing, this transmission light of the pulse laser beam becomes self-focused without diffusing inside the workpiece 41 and proceeds in a depth direction parallel to the Z-axis direction as illustrated in FIG. 5C. Then, the self-focused pulse laser beam progresses the ablation processing in the depth direction. Accordingly, the hole H having such a high aspect ratio that the hole H has a diameter of 10 μm to 150 μm approximately and the processing depth ΔZd is 1.5 mm or larger is processed as illustrated in FIG. 5D.

Such a processing result of composition of the hole H having a high aspect ratio suggests that the pulse laser beam is self-focused inside the workpiece 41 for some reason as illustrated in FIG. 5C. It is thought that the self-focusing occurs because reforming occurs to the optical path through which the pulse laser beam passes inside the workpiece 41, and a reforming layer RF elongated in the depth direction is generated as illustrated in FIG. 5C.

One hypothesis is such that the self-focusing occurs because the refractive index is increased at the reforming layer RF as compared to the other part due to transmission of the pulse laser beam. Another hypothesis is such that the self-focusing occurs because the pulse laser beam travels in the depth direction through repetition of Fresnel reflection at the inner wall surface of the hole H, which is the boundary between the reforming layer RF and a non-reforming part, as if light is propagating inside an optical fiber.

Irrespective of these reasons of the self-focusing, it was observed that a hole having a high aspect ratio was accurately processed when the laser processing was performed on the workpiece 41 under the above-described processing conditions.

2.3 Problem

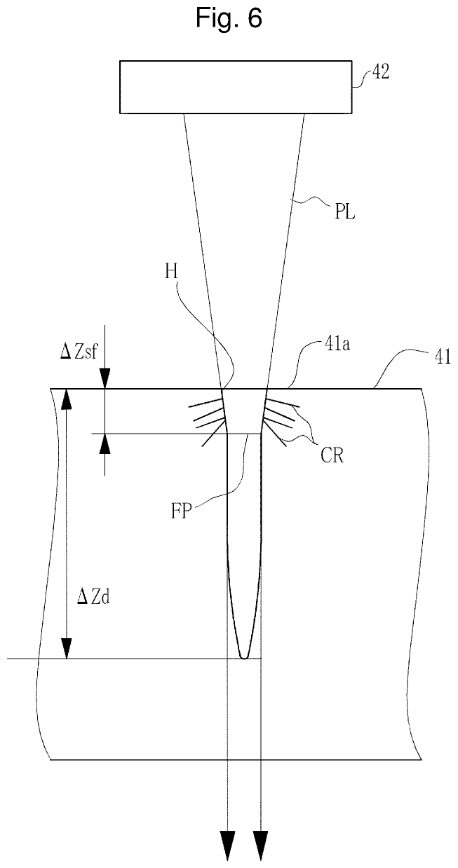

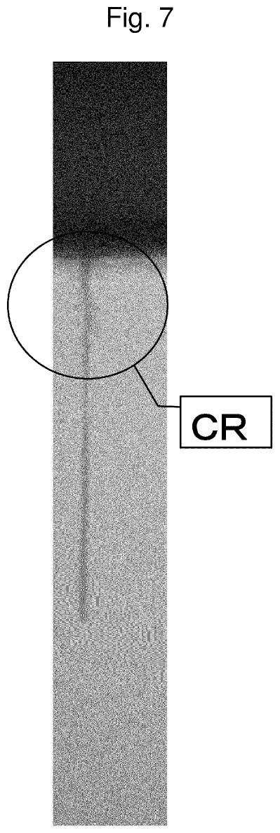

In the laser processing system 2 according to the comparative example described above, a hole having a high aspect ratio can be processed, but a crack CR extending like a small branch near the hole H on the surface 41a in the radial direction of the hole H is sometimes generated as illustrated in FIG. 6. FIG. 7 is a picture obtained through image capturing of an actual processing state of the hole H, in which a circle is illustrated where the crack CR is generated.

3. Crack Generation Factor Analysis

The inventors performed an experiment to analyze a factor of generation of the crack CR. Discussion on a result of the experiment concludes that the factor of the crack CR relates to a maximum fluence Fsfp of the pulse laser beam, to be described later, on the surface 41a of the workpiece 41.

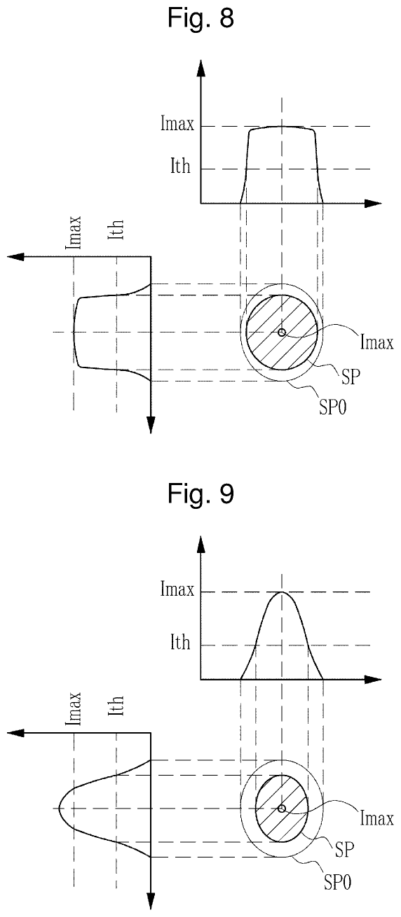

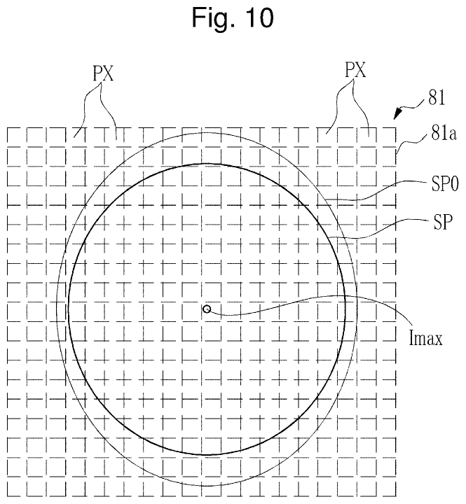

FIGS. 8 and 9 each illustrate an exemplary beam profile that is distribution of light intensity at a beam section SP of the pulse laser beam PL in the radial direction. FIG. 8 illustrates an exemplary top-hat beam profile in which distribution of light intensity in the radial direction is substantially uniform. FIG. 9 illustrates an exemplary Gaussian distribution beam profile in which distribution of light intensity in the radial direction is maximum at the center and largely drops around the center. Each beam profile is measured by detecting a light intensity I in the beam section SP through an image sensor 81a of a beam profiler 81 inserted at a position on the optical axis of the pulse laser beam PL as illustrated in FIG. 10.

As illustrated in FIG. 10, the image sensor 81a has a light receiving surface on which a plurality of pixels PX are two-dimensionally arrayed and outputs, for each pixel PX, an electric signal indicating the light intensity I of the pulse laser beam PL incident thereon. The image sensor 81a is, for example, a charge coupled device (CCD) image sensor or a complementary metal oxide semiconductor (CMOS) image sensor. The beam profiles illustrated in FIGS. 8 and 9 are obtained by plotting such light intensity I output for each pixel PX in the radial direction of the beam section SP.

More accurately, the area of the section SP is the area of a part at which the light intensity I equal to or higher than a threshold Ith is detected in a total beam section SP0. The threshold Ith is a value equal to 1/e² of the maximum value among the light intensities I output from the respective pixels PX.

The target fluence Ft (J/cm²) is an average fluence in the beam section SP at the transfer position FP. Thus, the target fluence Ft corresponds to a value calculated based on an average light intensity Iavs in the entire range of the beam section SP at the transfer position FP.

The maximum fluence Fsfp is the maximum value among fluences of a plurality of small regions obtained by dividing the beam section SP of the pulse laser beam on the surface 41a of the workpiece 41. Thus, the maximum fluence Fsfp is a value obtained with respect to the maximum value among the light intensities I of the small regions in the beam section SP on the surface 41a.

In the present example, each small region is the region of one pixel PX of the image sensor 81a. In this case, the maximum fluence Fsfp is calculated based on the maximum value among the light intensities I detected at the respective pixels PX. The diameter Di of the section SP at the transfer position FP is 10 μm to 150 μm. The size of each pixel PX depends on the resolution of the image sensor 81a. The size of each pixel PX is, for example, 4 μm×4 μm approximately. When the diameter Di is 10 μm to 150 μm, the resolution of the image sensor 81a is preferably 4 μm to 50 μm inclusive.

When a necessary resolution is ensured, a region as the sum of a plurality of pixels PX, for example, a region as the sum of four adjacent pixels PX may be set as one small region, and the maximum fluence Fsfp may be calculated based on the maximum value among the light intensities I detected at the respective small regions.

When the resolution of the image sensor 81a is relatively low, for example, when the size of each pixel PX of the image sensor 81a is larger than 4 μm×4 μm approximately, the transfer image obtained by enlarging the pulse laser beam may be imaged on the image sensor 81a at beam profile measurement. In this manner, the resolution of the beam profile of the pulse laser beam PL can be increased even when the resolution of the image sensor 81a is relatively low. The resolution of the beam profile in this case is preferably 4 μm to 50 μm inclusive as described above.

In a case of the top-hat beam profile as illustrated in FIG. 8, the light intensity I in the section SP has a maximum light intensity Imax at the center of the section SP but is substantially constant across the entire range of the section SP. Thus, the average light intensity Iavs in the section SP and the maximum light intensity Imax are substantially equal.

In a case of the Gaussian distribution beam profile as illustrated in FIG. 9, the light intensity I in the section SP has the maximum light intensity Imax at the center of the section SP and largely drops around the center as compared to the top-hat beam profile. Thus, the average light intensity Iavs in the section SP is smaller than the maximum light intensity Imax and largely different from the maximum light intensity Imax.

The ratio of the maximum light intensity Imax relative to the average light intensity Iavs at a reference position is defined as a light intensity ratio R as expressed in Expression (4) below.

R=Imax/Iavs (4)

In a case of the top-hat beam profile as illustrated in FIG. 8, the light intensity ratio R is, for example, substantially equal to one. In a case of the Gaussian distribution beam profile as illustrated in FIG. 9, the light intensity ratio R is, for example, substantially equal to two or larger.

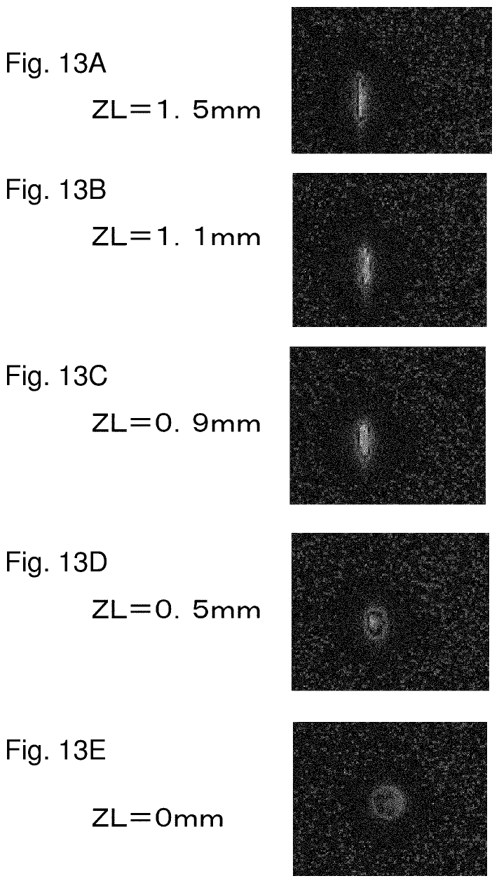

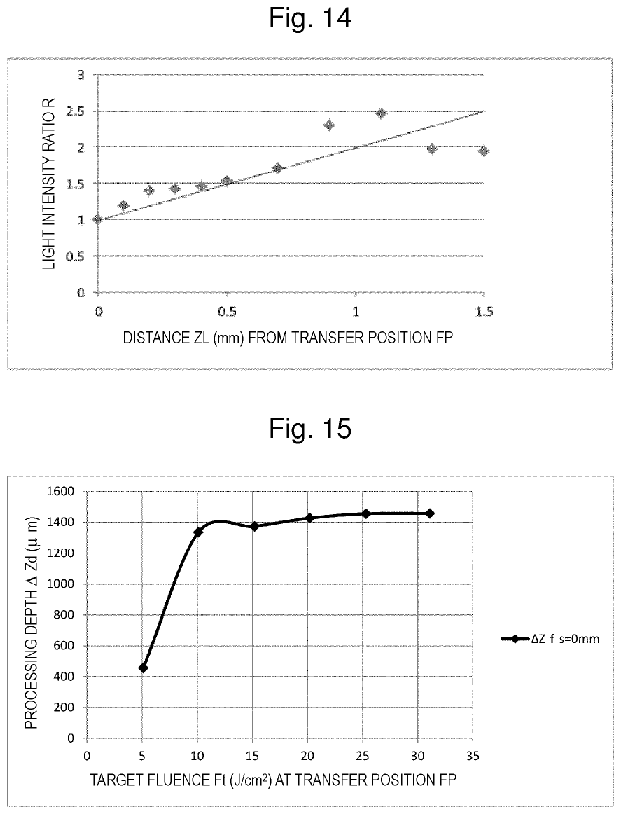

In the present example, the reference position is the transfer position FP, and the average light intensity Iavs is the average light intensity Iavs in the section SP at the transfer position FP. The maximum light intensity Imax is the maximum light intensity Imax in a beam profile at each position in the optical axis direction of the pulse laser beam PL. Thus, in the present example, the light intensity ratio R indicates the magnitude of the maximum light intensity Imax at each position in the optical axis direction relative to the average light intensity Iavs at the transfer position FP as described later with reference to FIGS. 13A to 13E and FIG. 14.

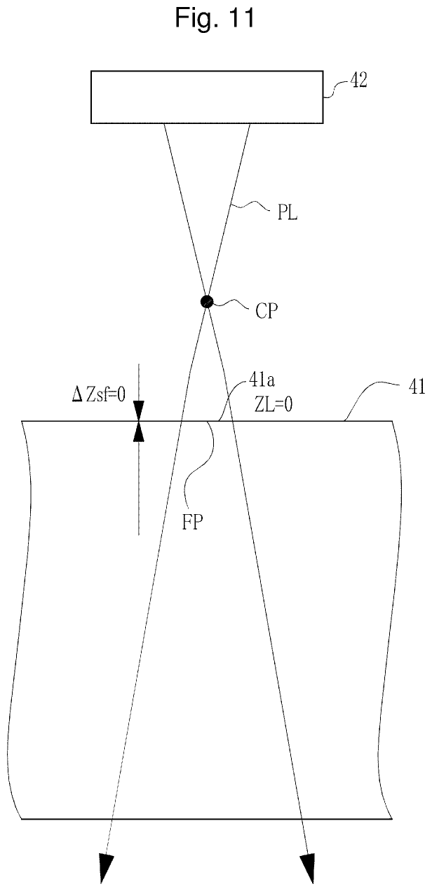

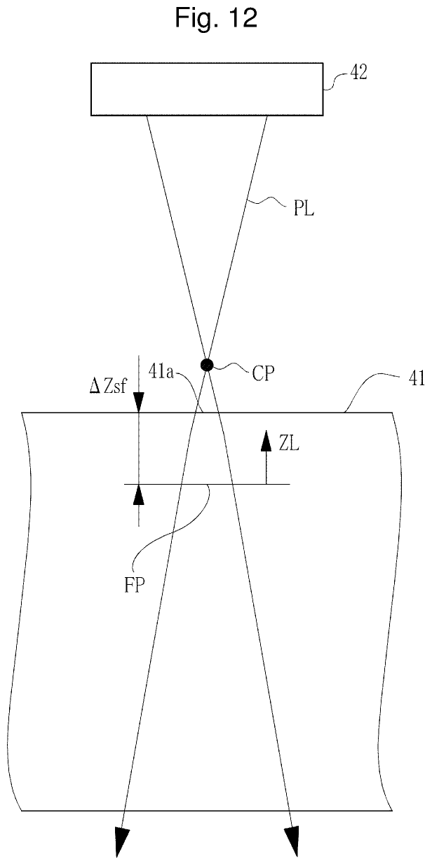

The area of the beam section SP of the pulse laser beam changes with the position in the Z-axis direction as illustrated in FIGS. 11 and 12. Although illustrated in a simplified manner in FIGS. 2A and 2B and FIGS. 5A to 5D, the pulse laser beam PL has light flux as illustrated in FIGS. 11 and 12, more accurately, when the transfer lens 48 is used. Specifically, the light flux of the pulse laser beam PL emitted from the window 42 temporarily condenses at a focal point CP, diffuses thereafter, and forms the transfer image at the transfer position FP. The area of the beam section SP decreases from the transfer position FP toward the focal point CP.

FIG. 11 illustrates an example in which the depth ΔZsf is 0 mm and the transfer position FP coincides with the surface 41a of the workpiece 41. In the case of FIG. 11, the target fluence Ft at the transfer position FP and the maximum fluence Fsfp at the surface 41a are substantially equal when the light intensity ratio R at the transfer position FP is substantially equal to one.

FIG. 12 illustrates an example in which the depth ΔZsf is, for example, 1 mm and the transfer position FP is inside from the surface 41a. In the case of FIG. 12, the target fluence Ft at the transfer position FP and the maximum fluence Fsfp at the surface 41a are not equal even when the light intensity ratio R at the transfer position FP is substantially equal to one. This is because the beam profile of the beam section SP changes in the optical axis direction of the pulse laser beam PL. Thus, the maximum light intensity Imax at the transfer position FP as the reference position and the maximum light intensity Imax at the surface 41a are not equal, and the light intensity ratio R changes.

FIGS. 13A to 13E illustrate data obtained by measuring the shape and light intensity distribution of the beam section SP at each position in the optical axis direction of the pulse laser beam PL. A distance ZL is the distance in the optical axis direction (Z-axis direction) with respect to the transfer position FP and defined to be positive in the direction from the transfer position FP toward the window 42 and the transfer lens 48.

In FIGS. 13A to 13E, FIG. 13E illustrates the shape and light intensity distribution of the beam section SP at the transfer position FP at ZL=0, and FIGS. 13D, 13C, 13B, and 13A illustrate the shape and light intensity distribution of the beam section SP at positions closer to the window 42 in the stated order. FIG. 13D illustrates the section SP at the distance ZL=0.5 mm, FIG. 13C illustrates the section SP at the distance ZL=0.9 mm, FIG. 13B illustrates the section SP at the distance ZL=1.1 mm, and FIG. 13A illustrates the section SP at the distance ZL=1.5 mm. FIGS. 13D to 13A each correspond to the section SP between the transfer position FP and the focal point CP.

The light intensity distribution is illustrated by change of grayscale in the section SP, and difference in the light intensity I is larger for larger difference in grayscale. FIGS. 13A to 13E indicate that the difference in concentration between a central part and its periphery in the section SP at the distance ZL is larger in the order from FIG. 13E to FIG. 13A.

At the transfer position FP illustrated in FIG. 13E, the shape of the beam section SP is circular in accordance with the shape of the pinhole of the transfer mask 47, and the light intensity distribution in the section SP has a substantially flat top-hat shape. As illustrated in FIGS. 13E to 13A, as the distance ZL from the transfer position FP increases, the shape of the section SP becomes closer to an ellipse, and the beam profile in the radial direction of the section SP becomes closer to a Gaussian distribution having large difference between the center and its periphery. In this manner, the beam profile of the section SP changes in the optical axis direction of the pulse laser beam PL. As a result, the light intensity ratio R changes in accordance with the distance ZL as specifically illustrated in FIG. 14.

FIG. 14 illustrates correlation data of the distance ZL and the light intensity ratio R, which is generated from the measurement data illustrated in FIGS. 13E to 13A. As described above, the light intensity ratio R is a value indicating the magnitude of the maximum light intensity Imax at each position as illustrated in FIGS. 13E to 13A relative to the average light intensity Iavs at the transfer position FP as the reference position, which is illustrated in FIG. 13E.

At the transfer position FP, since the beam profile of the section SP has a top-hat shape, the light intensity ratio R is substantially equal to one as illustrated in the graph of FIG. 14. While the distance ZL changes from 0 mm to 1.5 mm, in other words, the position changes from the transfer position FP to the focal point CP, the light intensity ratio R increases as the distance ZL increases, and the light intensity ratio R is 1.5, 2, and 2.5 at the distance ZL=0.5 mm, 1.0 mm, and 1.5 mm, respectively. This indicates that the beam profile of the section SP becomes closer to a shape like the Gaussian distribution as the distance ZL increases, and as a result, the maximum light intensity Imax at the distance ZL is higher than the average light intensity Iavs at the transfer position FP.

Thus, when the transfer position FP is set at the surface 41a as illustrated in FIG. 11 and the beam profile has, for example, a top-hat shape as illustrated in FIG. 8, the target fluence Ft at the transfer position FP and the maximum fluence Fsfp at the surface 41a are substantially equal. However, when the transfer position FP is set at a position inside from the surface 41a as illustrated in FIG. 12, the maximum fluence Fsfp at the surface 41a is larger than the target fluence Ft at the transfer position FP as understood from the relation between the distance ZL and the light intensity ratio R, which is illustrated in FIG. 14.

The maximum fluence Fsfp at the surface 41a of the workpiece 41 can be obtained by an expression below from the light intensity ratio R and the target fluence Ft at the transfer position FP.

Fsfp=R·Ft (5)

For example, the light intensity ratio R is two at the distance ZL=1.0 mm. This means that the maximum light intensity Imax at the position of the distance ZL=1.0 mm is twice as high as the average light intensity Iavs at the transfer position FP. Thus, the maximum fluence Fsfp at the distance ZL=1.0 mm is twice as large as the target fluence Ft with respect to the average light intensity Iavs at the transfer position FP.

Discussion on such a relation between the maximum fluence Fsfp and the target fluence Ft and experiment results in FIGS. 15 to 20 described below concludes that the maximum fluence Fsfp at the surface 41a of the workpiece 41 relates to the crack CR.

FIG. 15 is a graph illustrating the relation between the target fluence Ft at the transfer position FP and the processing depth ΔZd. The horizontal axis represents the target fluence Ft, and the vertical axis represents the processing depth ΔZd. The irradiation conditions in the case of FIG. 15 are such that the diameter Di of the beam section SP at the transfer position FP is 55 μm, the repetition frequency f is 1 kHz, the irradiation pulse number N is 5000 pulses, and the duration of irradiation is 5 sec. In the example of FIG. 15, a depth ΔZfs is zero, and the transfer position FP coincides with the surface 41a as illustrated in FIG. 11.

In the example of FIG. 15, the target fluence Ft is changed from 5 J/cm² to 30 J/cm². As understood from the graph of FIG. 15, a hole having such a high aspect ratio that the processing depth ΔZd is 1 mm or larger is processed when the target fluence Ft is 10 J/cm² to 30 J/cm². In this range of the target fluence Ft, the crack CR is not generated.

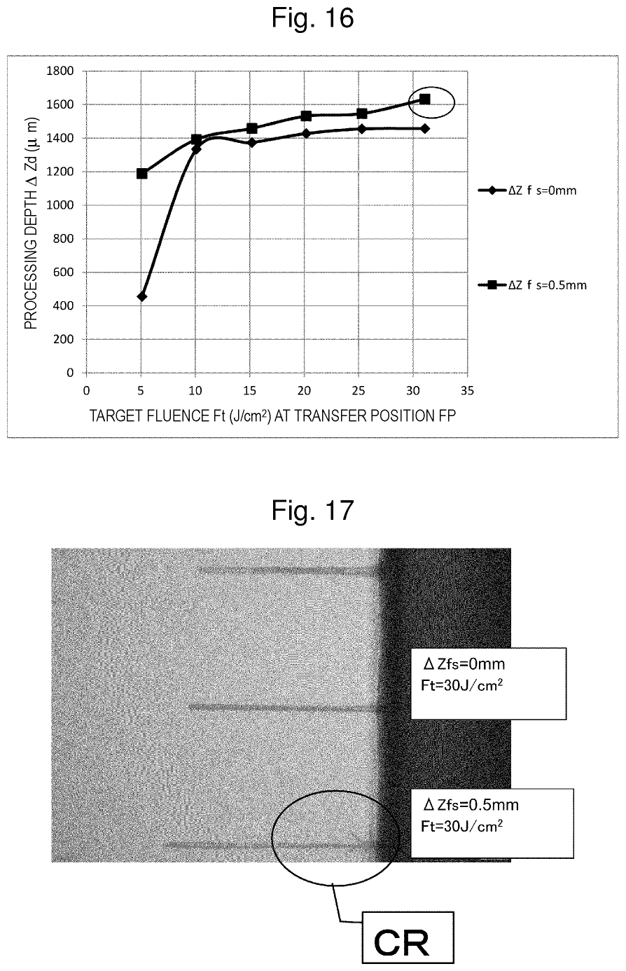

FIG. 16 illustrates a graph for the depth ΔZfs=0.5 mm in addition to the graph illustrated in FIG. 15 for the depth ΔZfs=0. Plot points in the graph for the depth ΔZfs=0 are illustrated as rhombi, and plot points in the graph for the depth ΔZfs=0.5 mm are illustrated as rectangles. The other irradiation conditions are identical to those in FIG. 15.

As illustrated in FIG. 16, for the depth ΔZfs=0.5 mm as well, a hole having such a high aspect ratio that the processing depth ΔZd is 1 mm or larger is processed when the target fluence Ft is 10 J/cm² to 30 J/cm². However, for the depth ΔZfs=0.5 mm, the crack CR is not generated until the target fluence Ft becomes equal to 25 J/cm², but the crack CR is generated at 30 J/cm², which is indicated by a circle.

FIG. 17 is a picture illustrating the state of the hole H when the hole processing is performed with the depth ΔZfs set to be 0 mm and the state of the hole H when the hole processing is performed with the depth ΔZfs set to be 0.5 mm while the target fluence Ft is set to be 30 J/cm². As illustrated in FIG. 17, the crack CR is not generated in the case of the depth ΔZfs=0 mm, but the crack CR is generated in the case of the depth ΔZfs=0.5 mm.

In the case of the depth ΔZfs=0 mm, the light intensity ratio R is substantially equal to one as understood from the graph of FIG. 14 because of the distance ZL=0 mm. Thus, the maximum fluence Fsfp is substantially equal to 30 J/cm² and unchanged when the target fluence Ft at the transfer position FP is 30 J/cm². However, in the case of the depth ΔZfs=0.5 mm, the light intensity ratio R is substantially equal to 1.5 as understood from the graph of FIG. 14 because of the distance ZL=0.5 mm. Thus, the maximum fluence Fsfp is substantially equal to 45 J/cm² even when the target fluence Ft at the transfer position FP is 30 J/cm².

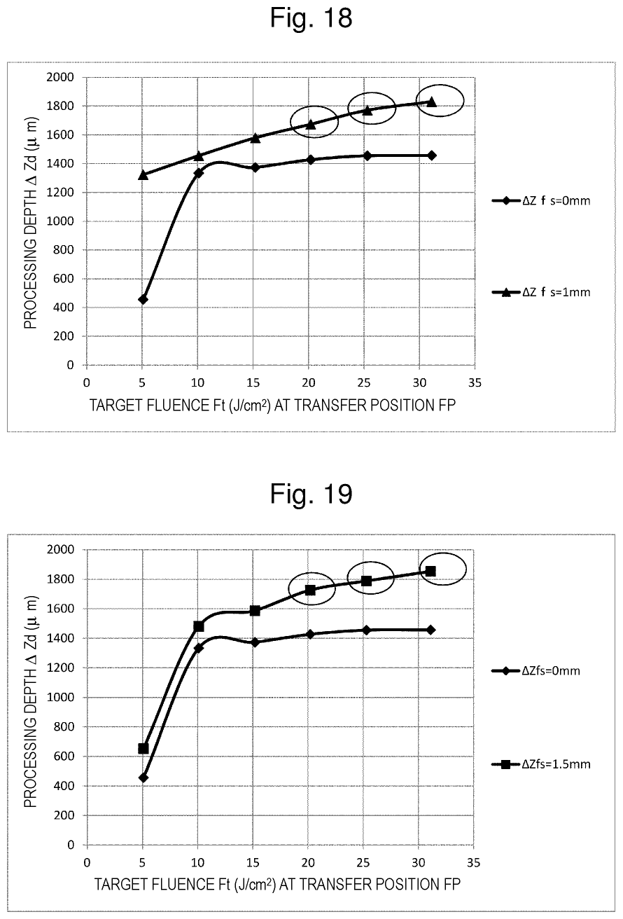

Similarly to FIG. 16, FIGS. 18 and 19 illustrate graphs of experiment results. Similarly to FIG. 16, the graph of FIG. 15 is illustrated in FIGS. 18 and 19 as well for comparison.

FIG. 18 illustrates an example in which the depth ΔZfs is set to be 1 mm, and in FIG. 18, plot points in the graph for the depth ΔZfs=1 mm are illustrated with triangles. In FIG. 18, the graph with rhombus plot points is the graph for the depth ΔZfs=0 mm in FIG. 15. FIG. 19 illustrates an example in which the depth ΔZfs is set to be 1.5 mm, and in FIG. 19, plot points in the graph for the depth ΔZfs=1.5 mm are illustrated with asterisks. In FIG. 19 as well, the graph with rhombus plot points is the graph for the depth ΔZfs=0 mm in FIG. 15. In FIGS. 18 and 19, the irradiation conditions other than the depth ΔZfs are same as those in the example of FIG. 15.

As illustrated in FIGS. 18 and 19, in the case of the depth ΔZfs=0.5 mm as well, a hole having such a high aspect ratio that the processing depth ΔZd is 1 mm or larger is processed when the target fluence Ft is 10 J/cm² to 30 J/cm².

However, in FIGS. 18 and 19, the crack CR is generated when the target fluence Ft is 20 J/cm² to 30 J/cm² as illustrated with circles.

In the case of the depth ΔZfs=1 mm, the light intensity ratio R is substantially equal to two as understood from the graph of FIG. 14 because of the distance ZL=1 mm. Thus, the maximum fluence Fsfp is substantially equal to 40 J/cm² when the target fluence Ft at the transfer position FP is 20 J/cm². Similarly, the maximum fluence Fsfp is substantially equal to 60 J/cm² when the target fluence Ft is 30 J/cm².

In the case of the depth ΔZfs=1.5 mm, the light intensity ratio R is substantially equal to 2.5 as understood from the graph of FIG. 14 because of the distance ZL=1.5. Thus, the maximum fluence Fsfp is substantially equal to 50 J/cm² even when the target fluence Ft at the transfer position FP is 20 J/cm². Similarly, the maximum fluence Fsfp is substantially equal to 75 J/cm² when the target fluence Ft is 30 J/cm².

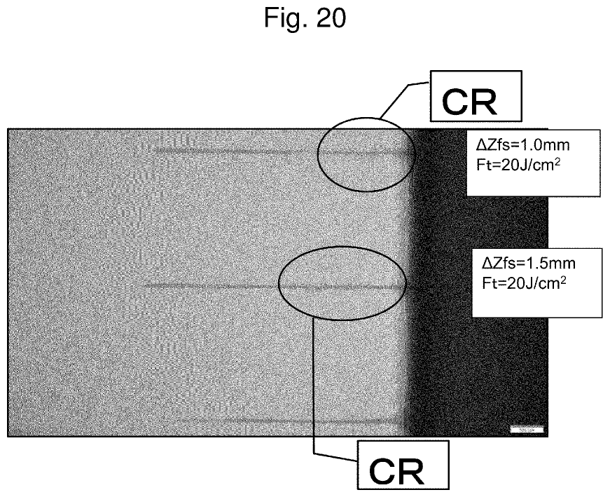

FIG. 20 is a picture illustrating the state of the hole H when the hole processing is performed with the depth ΔZfs set to be 1 mm in FIG. 18 and the state of the hole H when the hole processing is performed with the depth ΔZfs set to be 1.5 mm in FIG. 19 while the target fluence Ft is set to be 20 J/cm². As illustrated in FIG. 20, the crack CR is generated in each case of the depth ΔZfs=1 mm or 1.5 mm.

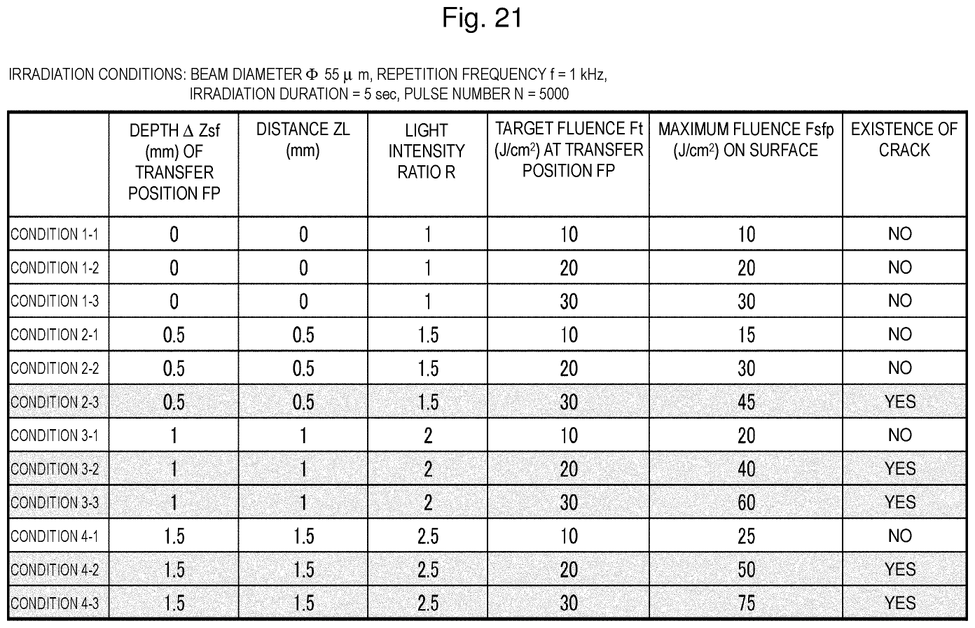

FIG. 21 illustrates a table listing the experiment results of FIGS. 15 to 19. In FIG. 21, data of Conditions 1-1 to 1-3 corresponds to the experiment results illustrated in the graph of FIG. 15. Specifically, the data of Conditions 1-1 to 1-3 corresponds to experiment results when the hole processing is performed while the depth ΔZfs is set to be zero and the target fluence Ft is set to be 10 J/cm², 20 J/cm², and 30 J/cm², respectively.

Similarly, in FIG. 21, data of Conditions 2-1 to 2-3 corresponds to the experiment results illustrated in the graph of FIG. 16. Specifically, the data of Conditions 2-1 to 2-3 corresponds to experiment results when the hole processing is performed while the depth ΔZfs is set to be 0.5 mm and the target fluence Ft is set to be 10 J/cm², 20 J/cm², and 30 J/cm², respectively.

Similarly, in FIG. 21, data of Conditions 3-1 to 3-3 corresponds to the experiment results illustrated in the graph of FIG. 18. Specifically, the data of Conditions 3-1 to 3-3 corresponds to experiment results when the hole processing is performed while the depth ΔZfs is set to be 1 mm and the target fluence Ft is set to be 10 J/cm², 20 J/cm², and 30 J/cm², respectively.

Similarly, in FIG. 21, data of Conditions 4-1 to 4-3 corresponds to the experiment results illustrated in the graph of FIG. 19. Specifically, the data of Conditions 4-1 to 4-3 corresponds to experiment results when the hole processing is performed while the depth ΔZfs is set to be 1.5 mm and the target fluence Ft is set to be 10 J/cm², 20 J/cm², and 30 J/cm², respectively.

In FIG. 21, as illustrated in conditions of grayed out cells such as Conditions 2-3, 3-2, 3-3, 4-2, and 4-3, the crack CR is generated when the maximum fluence Fsfp at the surface 41a is 40 J/cm² or larger. The inventors have found from these experiment results that the maximum fluence Fsfp is thought to be the factor of the crack CR.

4. Laser Processing System and Laser Processing Method of First Embodiment

4.1 Configuration

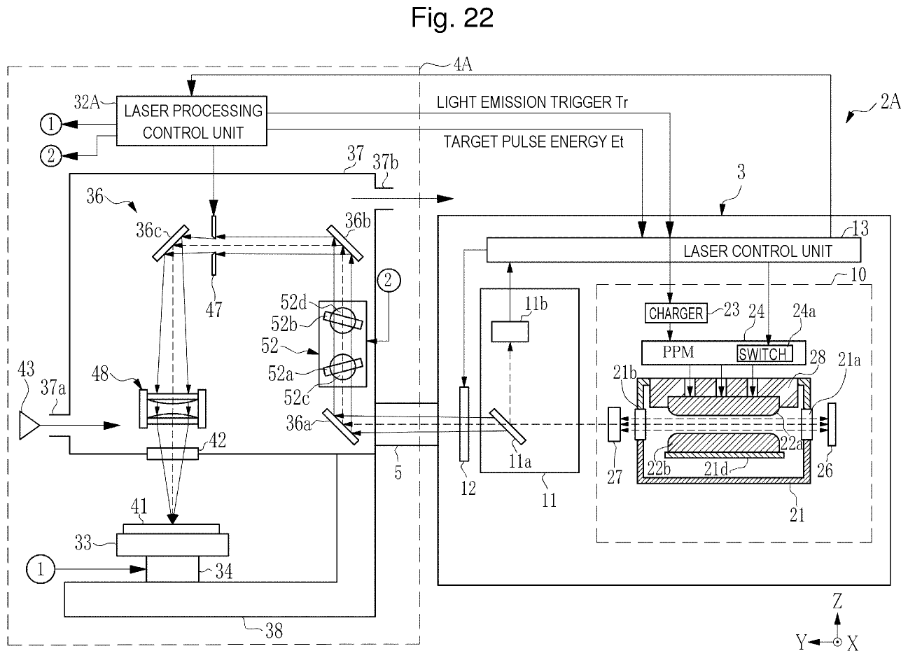

FIG. 22 schematically illustrates a configuration of a laser processing system 2A according to a first embodiment. The laser processing system 2A of the first embodiment includes a laser processing device 4A in place of the laser processing device 4 of the laser processing system 2 of the comparative example described with reference to FIG. 1. The following description of the first embodiment is mainly made on any difference from the laser processing system 2 of the comparative example, and any identical component is denoted by an identical reference sign and description thereof is omitted.

Unlike the laser processing device 4 of the comparative example, the laser processing device 4A of the first embodiment includes a laser processing control unit 32A in place of the laser processing control unit 32. The other configuration of the laser processing device 4A is same as that of the laser processing device 4 of the comparative example.

The laser processing control unit 32A is different from the laser processing control unit 32 of the comparative example in that processing of determining whether the maximum fluence Fsfp at the surface 41a of the workpiece 41 is within a predetermined range based on the target fluence Ft at the transfer position FP, which is set as an irradiation condition, is added before the laser processing. The other features are same as those of the laser processing control unit 32A.

4.2 Operation

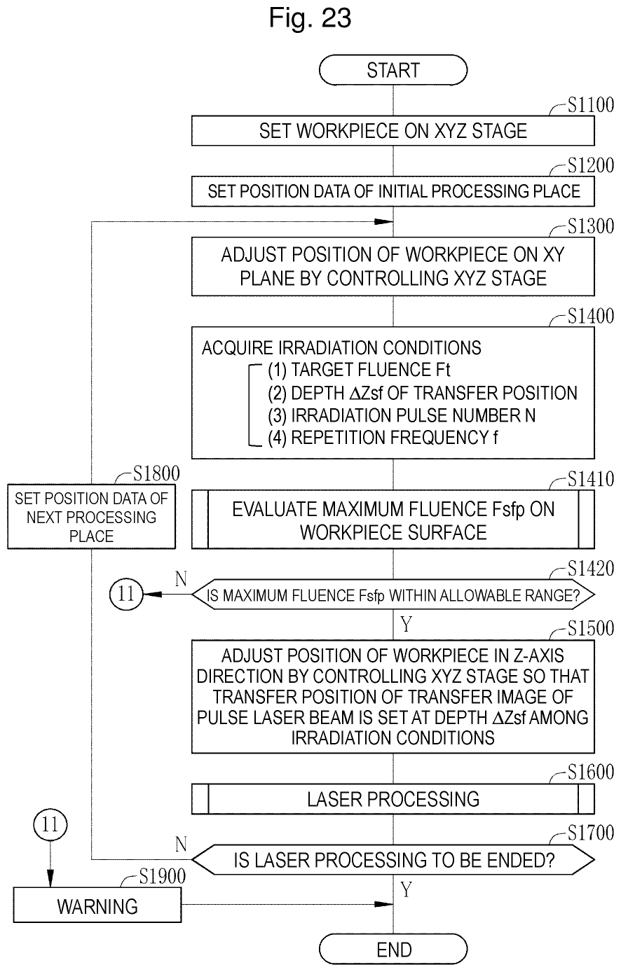

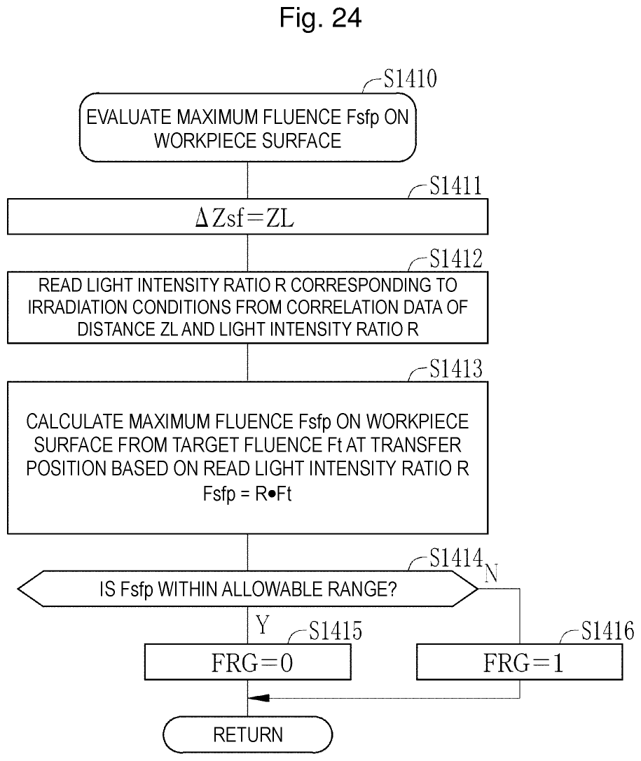

The following describes operation of the laser processing system 2A with reference to FIGS. 23 and 24. The flowchart of FIG. 23 in the first embodiment is different from the flowchart of FIG. 3 in the comparative example in that steps S1410 and S1420 are added between steps S1400 and S1500, and step S1900 is added. The other features are same.

Similarly to the comparative example, the laser processing control unit 32A of the first embodiment executes processing at S1100 to S1400. Thereafter, the laser processing control unit 32A of the first embodiment executes processing at S1410 and S1420. S1410 is processing of evaluating the maximum fluence Fsfp at the surface 41a of the workpiece 41. S1420 is processing of determining whether the maximum fluence Fsfp is within an allowable range based on a result of the evaluation at S1410. Data of the allowable range is stored in, for example, a memory in the laser processing control unit 32A or an external storage in advance. When the maximum fluence Fsfp is determined to be within the allowable range at S1420 (Y at S1420), the laser processing control unit 32A proceeds to S1500. The subsequent processing is same as that of the comparative example.

In this manner, the laser processing control unit 32A functions as a determination unit configured to determine whether the maximum fluence Fsfp of the pulse laser beam PL at the surface 41a of the workpiece 41 as a transparent material is within a predetermined allowable range. In addition, the laser processing control unit 32A functions as a control unit configured to allow irradiation with the pulse laser beam PL when the maximum fluence Fsfp is determined to be within the predetermined allowable range.

When the maximum fluence Fsfp is determined to be out of the allowable range at S1420 (N at S1420), the laser processing control unit 32A proceeds to S1900 and performs warning. The content of the warning notifies that the laser processing cannot be performed because the crack CR is potentially generated with set irradiation conditions. In the warning processing, the laser processing control unit 32A controls a display (not illustrated) to notify a user of a message of such content. Alternatively, the laser processing control unit 32A may control a speaker to give notification of the message by voice. Moreover, notification of the warning message may be given to a factory management system configured to manage a factory in place of or in addition to the display and speaker of the laser processing system 2A.

FIG. 24 is a flowchart illustrating the procedure of evaluation processing of the maximum fluence Fsfp at S1410. The laser processing control unit 32A reads the value of the depth ΔZsf from the data of the irradiation conditions and sets the read ΔZsf as the distance ZL in the memory (S1411). At S1412, the laser processing control unit 32A reads the light intensity ratio R corresponding to the irradiation conditions from the correlation data of the distance ZL and the light intensity ratio R, which is illustrated in FIG. 14. Specifically, the light intensity ratio R corresponding to the distance ZL to which the value of the depth ΔZsf is set at S1411 is read (S1412).

The correlation data illustrated in FIG. 14 is stored in the memory of the laser processing control unit 32A or an external storage in advance. The correlation data may be recorded in a table format or a function format.

Based on the read light intensity ratio R, the laser processing control unit 32A calculates the maximum fluence Fsfp at the surface 41a of the workpiece 41 from the target fluence Ft at the transfer position FP by Expression (5) described above (S1413).

When the maximum fluence Fsfp is determined to be within the allowable range at S1414, the laser processing control unit 32A records “0” to a flag FRG as the evaluation result (S1415). When the maximum fluence Fsfp is determined to be out of the allowable range at S1414, the laser processing control unit 32A records “1” to the flag FRG as the evaluation result (S1416). Thereafter, the laser processing control unit 32A returns to the main routine illustrated in FIG. 23 and executes S1420.

4.3 Effect

As described above, in the laser processing in which a hole having a high aspect ratio is processed through irradiation with the pulse laser beam PL, the laser processing system 2A of the first embodiment allows the irradiation with the pulse laser beam when the maximum fluence Fsfp is determined to be within the allowable range. Thus, generation of the crack CR can be reduced.

When the maximum fluence Fsfp is determined to be out of the allowable range, the laser processing system 2A performs warning. Thus, the user can reliably understand that the irradiation conditions are inappropriate. In addition, when the maximum fluence Fsfp is determined to be out of the allowable range, the laser processing system 2A prohibits the laser processing. Thus, generation of the crack CR can be prevented.

When the maximum fluence Fsfp is determined to be out of the allowable range, the laser processing control unit 32A may automatically change the irradiation conditions to appropriate irradiation conditions with which the crack CR is not potentially generated and may perform the laser processing.

4.4 Preferable Processing Conditions

4.4.1 Pulse Width of Pulse Laser Beam

When an ultraviolet pulse laser beam is used, the pulse laser beam is desired to have a pulse width in the nanosecond order of 1 ns to 100 ns at full width at half maximum. This is because the pulse width is determined by the performance of the laser apparatus 3 and at this moment, it is difficult to manufacture the laser apparatus 3 capable of outputting an ultraviolet pulse laser beam having a pulse width of a picosecond order and high pulse energy. When an ultraviolet pulse laser beam in a nanosecond order is used as in the present example, the laser apparatus 3 that is easily available at this moment can be used.

The pulse width is preferably 1 ns to 100 ns at full width at half maximum, more preferably 10 ns to 20 ns. It is preferable to use a laser apparatus capable of outputting a pulse laser beam having such a pulse width as the laser apparatus 3.

Preferable processing conditions when such an ultraviolet pulse laser beam in a nanosecond order is used to process a hole having a high aspect ratio in the workpiece 41 as a transparent material such as synthetic quartz glass, which is transparent to ultraviolet light are as follows.

4.4.2 Range of Beam Diameter Di

The beam diameter Di of the pulse laser beam PL at the transfer position FP is preferably 10 μm to 150 μm inclusive. This is because, in a case in which the pulse laser beam PL that is ultraviolet light is used, the phenomenon as illustrated in FIGS. 5A to 5D occurs when the diameter Di is 10 μm to 150 μm inclusive. Such a phenomenon is a basis condition for processing a hole having a high aspect ratio.

4.4.3 Preferable Conditions when Workpiece 41 is Synthetic Quartz Glass

4.4.3.1 Wavelength of Pulse Laser Beam

When the hole processing is performed on synthetic quartz glass, the pulse laser beam preferably has a central wavelength of 157.6 nm to 248.7 nm. In particular, the pulse laser beam is preferably an ArF laser beam having a central wavelength substantially equal to 193.4 nm.

4.4.3.2 Range of Depth ΔZsf

The depth ΔZsf is preferably 0 mm to 4 mm inclusive. It is known from an experiment result that, up to a certain value, the processing depth ΔZd increases as the depth ΔZsf is increased. However, when the depth ΔZsf exceeds 4 mm approximately, the processing depth ΔZd largely becomes smaller than 1 mm, and a hole having a high aspect ratio cannot be processed. This is thought to be because, when the transfer position FP becomes too deep, the fluence near the surface 41a of the workpiece 41 becomes insufficient, and the ablation processing near the surface 41a does not proceed, and as a result, the ablation processing does not proceed in the depth direction as well.

4.4.3.3 Range of Target Fluence Ft

The target fluence Ft is preferably 5 J/cm² to 30 J/cm² inclusive. It is known that a hole having a high aspect ratio as illustrated in FIG. 5D cannot be processed when the target fluence Ft is smaller than 5 J/cm². Specifically, the lower limit value of the preferable range of the target fluence Ft is 5 J/cm². In addition, as illustrated in FIGS. 16 to 21, when the depth ΔZfs of the transfer position FP is 0.5 mm to 1.5 mm inclusive, generation of the crack CR is concerned when the target fluence Ft exceeds 30 J/cm². Thus, the upper limit value of the preferable range of the target fluence Ft is 30 J/cm².

4.4.3.4 Allowable Range of Maximum Fluence Fsfp

The allowable range of the maximum fluence Fsfp is preferably 10 J/cm² to 40 J/cm² inclusive based on the experiment results illustrated in FIGS. 15 to 21. The value of 10 J/cm² at the lower limit of the allowable range is based on 5 J/cm² as the lower limit value of the target fluence Ft necessary for processing a hole having a high aspect ratio.

As illustrated in the graph of FIG. 14, the maximum value of the light intensity ratio R is equal to or larger than two, depending on the value of the distance ZL. Thus, 10 J/cm² is obtained when 5 J/cm² as the lower limit value of the target fluence Ft is multiplied by “2” as a lowest estimation of the maximum value of the light intensity ratio R. Specifically, the target fluence Ft needs to be 5 J/cm² at lowest to process a hole having a high aspect ratio, and thus, when the light intensity ratio is set to be equal to or larger than two, the maximum fluence Fsfp is equal to or larger than 10 J/cm². This is the reason why the lower limit value of the maximum fluence Fsfp is set to be 10 J/cm².

The crack CR is generated when the maximum fluence Fsfp exceeds 40 J/cm² as illustrated in FIG. 21. Thus, the upper limit value of the allowable range is preferably 40 J/cm².

4.4.3.5 Range of Irradiation Pulse Number N

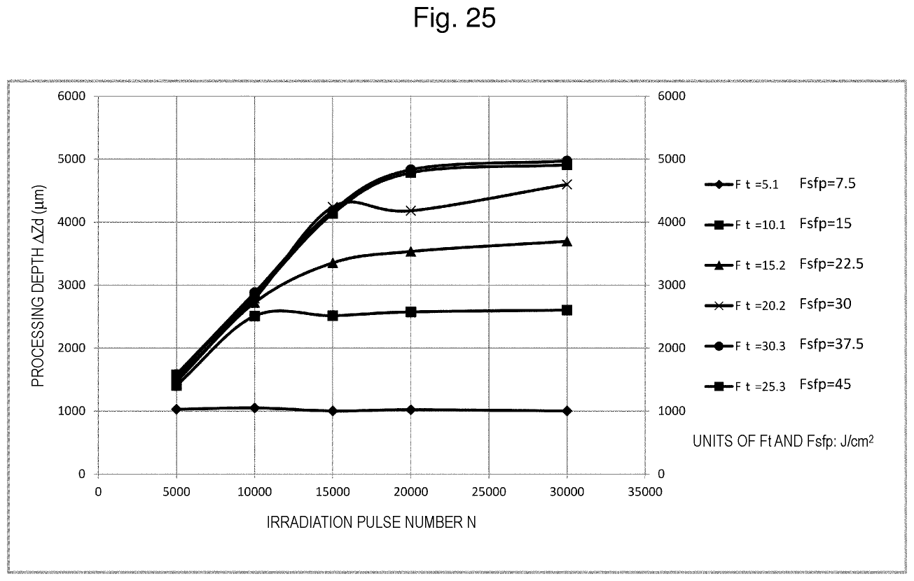

FIG. 25 is a graph illustrating a relation between the irradiation pulse number N and the processing depth ΔZd. Six graphs illustrated in FIG. 25 are obtained when the depth ΔZdsf of the transfer position FP is 0.5 mm. The graphs are different from each other in the values of the target fluence Ft and the maximum fluence Fsfp. FIG. 25 illustrates change of the processing depth ΔZd when the irradiation pulse number N is changed from 5,000 pulses to 30,000 pulses. The other irradiation conditions common to the graphs are such that the duration of irradiation is 5 sec to 30 sec, the diameter Di of the beam section SP is 55 μm, and the repetition frequency f is 1 kHz.

In FIG. 25, the graph with rhombus plot points is obtained when the target fluence Ft is 5.1 J/cm² and the maximum fluence Fsfp is 7.5 J/cm². The graph with rectangular plot points is obtained when the target fluence Ft is 10.1 J/cm² and the maximum fluence Fsfp is 15 J/cm². The graph with triangular plot points is obtained when the target fluence Ft is 15.2 J/cm² and the maximum fluence Fsfp is 22.5 J/cm².

The graph with cross plot points is obtained when the target fluence Ft is 20.2 J/cm² and the maximum fluence Fsfp is 30 J/cm². The graph with asterisk plot points is obtained when the target fluence Ft is 25.3 J/cm² and the maximum fluence Fsfp is 37.5 J/cm². The graph with circular plot points is obtained when the target fluence Ft is 30.3 J/cm² and the maximum fluence Fsfp is 45 J/cm².

As illustrated in FIG. 25, when the irradiation pulse number N is 5,000 pulses to 20,000 pulses, the processing depth ΔZd increases from 1 mm (1,000 μm) approximately to 5 mm (5,000 μm) approximately as the target fluence Ft is increased from 5 J/cm² approximately to 25 J/cm² approximately. The processing depth ΔZd is saturated when the irradiation pulse number N is 20,000 pulses, and does not increase by further increasing the irradiation pulse number N.

When the irradiation pulse number N is 5,000 pulses to 20,000 pulses, the hole processing in which the processing depth ΔZd is 5 mm (5,000 μm) at maximum can be performed. The aspect ratio for 5 mm (5,000 μm) as the maximum value of the processing depth ΔZd is 5,000 μm/55 μm=90 approximately where 55 μm is the diameter Di of the beam section SP. When the irradiation pulse number N is 5,000 pulses to 20,000 pulses, a hole having a high aspect ratio of 90 approximately at maximum can be processed. For these reasons, the irradiation pulse number N is preferably 5,000 pulses to 20,000 pulses.

4.5 Other

In the present example, relative positioning of the transfer position FP of the pulse laser beam PL and the workpiece 41 is performed by moving the workpiece 41 through control of the XYZ stage 34. Instead of moving the workpiece 41 in this manner, the relative positioning may be performed by moving the transfer mask 47 in the optical axis direction of the pulse laser beam. Specifically, the movement of the transfer mask 47 in the optical axis direction of the pulse laser beam PL is equivalent to change of the position of the transfer image transferred by the transfer lens 48 on the object side relative to the transfer lens 48, and thus the transfer position of the transfer image is changed in the optical axis direction. Accordingly, the relative positioning of the transfer position FP of the pulse laser beam PL and the workpiece 41 can be performed. In this case, the size of the transfer image is changed as the transfer mask 47 is moved relative to the transfer lens 48 in the optical axis direction. Such change of the diameter of the transfer image attributable to the movement of the transfer mask 47 may be prevented by changing the diameter of each pinhole of the transfer mask 47.

When the transfer image in a pinhole shape is transferred onto the workpiece 41 by using the transfer optical system as in the present example, change of the beam diameter is reduced as compared to a case in which the pulse laser beam is simply condensed and incident on the workpiece 41 as in a second embodiment to be described later. This is an advantage. The mode and beam diameter of the pulse laser beam output from the laser apparatus 3 change depending on a state of the optical resonator of the laser apparatus 3 or the like. However, when the transfer optical system is used, not the pulse laser beam is directly incident on the workpiece 41, but the pinhole-shaped transfer image of the pulse laser beam is formed through the transfer mask 47 and transferred onto the workpiece 41. This prevents change of the beam diameter attributable to mode change of the pulse laser beam.

In the present example, for the laser apparatus 3, an ArF excimer laser apparatus that uses ArF laser gas as a laser medium and outputs a pulse laser beam having a central wavelength of 193.4 nm approximately is described as an example, but the laser apparatus 3 may be another laser apparatus. For the laser apparatus 3, a KrF excimer laser apparatus that uses KrF laser gas as a laser medium and outputs a pulse laser beam having a central wavelength of 248.4 nm approximately may be used. When, for the workpiece 41, synthetic quartz glass is used, the range of the central wavelength of the pulse laser beam is preferably from 157.6 nm approximately, which is the central wavelength of F₂ laser, to 248.4 nm, which is the central wavelength of KrF laser.

The workpiece 41 is synthetic quartz glass in the above example, but is not limited thereto. The workpiece 41 may be any transparent material that is transparent to an ultraviolet pulse laser beam. The transparent material that is transparent to an ultraviolet pulse laser beam is, for example, MgF₂ crystal, CaF₂ crystal, sapphire, or quartz crystal.

5. Laser Processing System and Laser Processing Method of Second Embodiment

5.1 Configuration

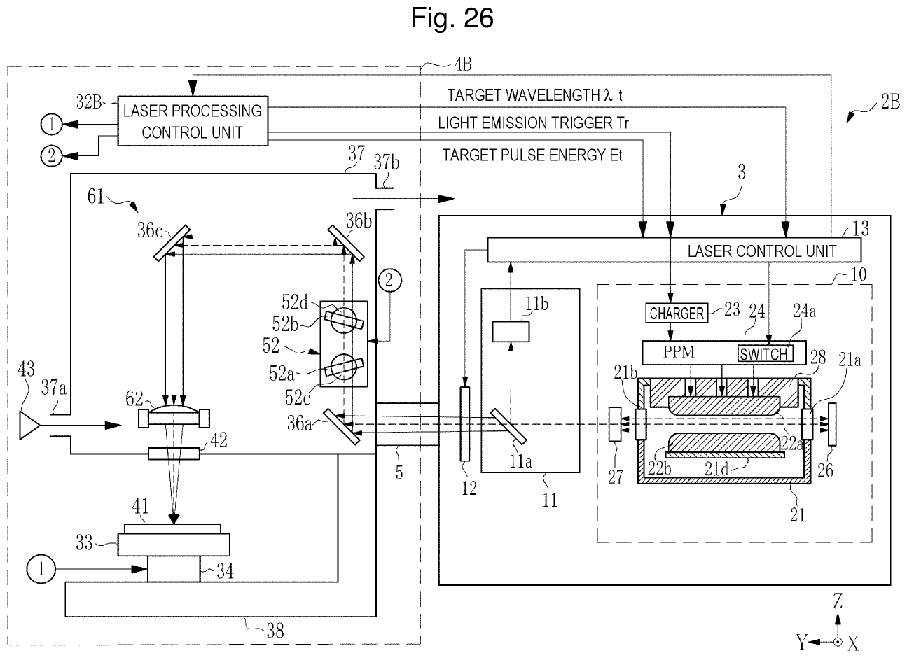

FIG. 26 illustrates a laser processing system 2B of the second embodiment. As illustrated in FIG. 26, the laser processing system 2B of the second embodiment includes the laser apparatus 3 and a laser processing device 4B. The laser apparatus 3 is same as that of the first embodiment. The laser processing device 4B includes an optical system 61 in place of the optical system 36 of the laser processing device 4A of the first embodiment. The optical system 61 does not include the transfer mask 47 nor the transfer lens 48 unlike the optical system 36 of the first embodiment, but includes a condensation optical system configured to directly condense a pulse laser beam output from the laser apparatus 3 and having Gaussian distribution and to emit the pulse laser beam to the workpiece 41.

A laser processing control unit 32B performs relative positioning of a beam waist position BW of the pulse laser beam PL and the workpiece 41 instead of performing relative positioning of the transfer position of the pulse laser beam and the workpiece 41 like the laser processing control unit 32A of the first embodiment. A depth ΔZsfw in the second embodiment is not the depth ΔZsf of the transfer position FP but is the depth of the beam waist position BW. A target fluence Ftw in the second embodiment is not the target fluence Ft at the transfer position FP but is a target fluence at the beam waist position BW. The laser processing control unit 32B determines whether the maximum fluence Fsfp at the surface 41a of the workpiece 41 is within the allowable range based on the target fluence Ftw at the beam waist position BW.

The other configuration of the laser processing system 2B is same as that of the laser processing system 2A of the first embodiment, and thus the following description will be mainly made on any difference.

The optical system 61 includes the high reflectance mirrors 36a to 36c, the attenuator 52, and a light condensation lens 62. The high reflectance mirrors 36a to 36c and the attenuator 52 are same as those of the optical system 36 of the first embodiment. The high reflectance mirror 36c reflects the pulse laser beam toward the light condensation lens 62.

The light condensation lens 62 is disposed to condense the pulse laser beam incident thereon onto the workpiece 41 through the window 42.

Similarly to the laser processing system 2A of the first embodiment, the laser processing system 2B of the second embodiment processes a hole having a processing diameter of 10 μm to 150 μm inclusive and a high aspect ratio in the workpiece 41. Thus, the laser processing system 2B irradiates the workpiece 41 with the pulse laser beam having a beam diameter Dw of 10 μm to 150 μm inclusive at the beam waist position BW. Similarly to the diameter Di illustrated in FIG. 9, the beam diameter Dw of the pulse laser beam PL at the beam waist position BW is a 1/e² full width as the width at a position where the value of 1/e² of the maximum light intensity Imax is obtained in the beam profile.

Unlike the laser processing system 2A, the laser processing system 2B irradiates the workpiece 41 with the pulse laser beam PL of the Gaussian distribution without conversion into the transfer image. Thus, the beam diameter of the pulse laser beam PL is determined by the specifications of the laser apparatus 3.

When the optical system 36 has no light loss, a fluence Fw at the beam waist position BW is obtained from Expression (6) below.

Fw=Et·T/{π(Dw/2)z} (6)

In the above expression, T represents the transmittance of the attenuator 52, Et represents the pulse energy of the pulse laser beam output from the laser apparatus, and Dw represents the diameter of the beam section SP at the beam waist position BW.

When the optical system 36 has no light loss, the transmittance T of the attenuator 52 is obtained by Expression (7) below from Expression (6).

T=π(Dw/2)²·Fw/Et (7)

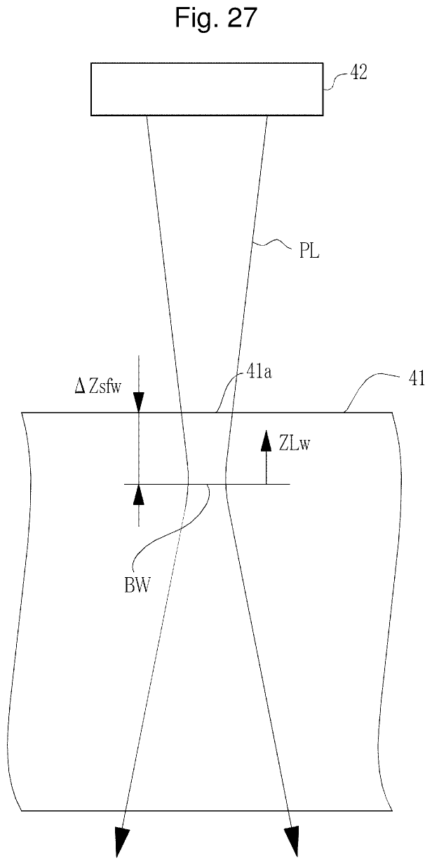

As illustrated in FIG. 27, after emission from the light condensation lens 62, the light flux of the pulse laser beam PL of the second embodiment is narrowed most at the beam waist position BW and diffuses thereafter. The diameter of the beam section SP is minimum at the beam waist position BW. In the second embodiment in which the light condensation lens 62 is used, the focal point CP (refer to FIG. 12) does not exist between the light condensation lens 62 and the workpiece 41 unlike the first embodiment in which the transfer lens 48 is used.

Thus, as illustrated in FIG. 27, the diameter and area of the beam section SP at the surface 41a are larger than the diameter and area of the beam section SP at the beam waist position BW even when the beam waist position BW is at the inside from the surface 41a.

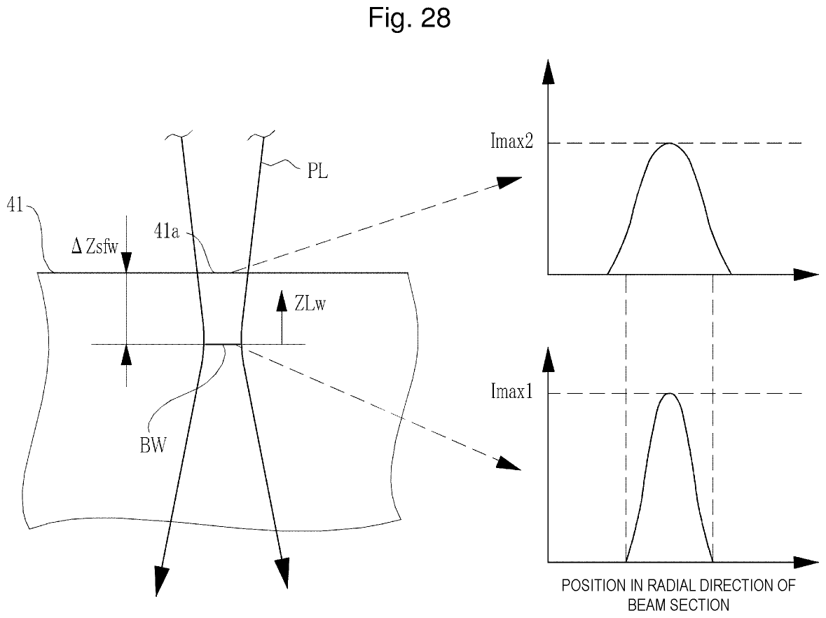

As illustrated in FIG. 28, the beam profile at the beam waist position BW and the beam profile at the surface 41a both have the Gaussian distribution. A maximum light intensity Imax1 at the beam waist position BW is larger than a maximum light intensity Imax2 at the surface 41a.

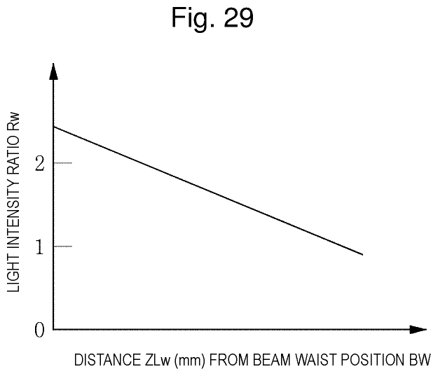

The pulse laser beam PL when the condensation optical system is used has such characteristics. Thus, in the second embodiment, a light intensity ratio Rw and a distance ZLw from the beam waist position BW to the surface 41a have a relation as illustrated in FIG. 29 where the distance ZLw corresponds to the distance ZL of the first embodiment.

The light intensity ratio Rw is a light intensity ratio when the pulse laser beam PL is condensed through a light condensation lens 62 and incident on the workpiece 41 as in the second embodiment, and is a light intensity ratio when the beam profile at the beam waist position BW is close to the Gaussian distribution. The light intensity ratio Rw can be obtained from Expression (8) below.

Rw=Imax/Iavw (8)

In the above expression, Iavw represents an average light intensity at the beam waist position BW, and Imax represents the maximum light intensity Imax at each position at the distance ZLw from the beam waist position BW.

The maximum fluence Fsfp at the surface 41a of the workpiece 41 can be obtained by Expression (9) below from the light intensity ratio Rw and the target fluence Ft at the transfer position FP.

Fsfp=Rw·Ftw (9)

In FIG. 29, the light intensity ratio Rw is maximum when the distance ZLw is 0, in other words, the beam waist position BW coincides with the surface 41a, and the light intensity ratio Rw decreases as the distance ZLw increases.

In the second embodiment, the laser processing control unit 32B determines whether the maximum fluence Fsfp at the surface 41a of the workpiece 41 is within the allowable range by using data of such a correlation between the distance ZLw and the light intensity ratio Rw, which is illustrated in FIG. 29.

5.2 Operation

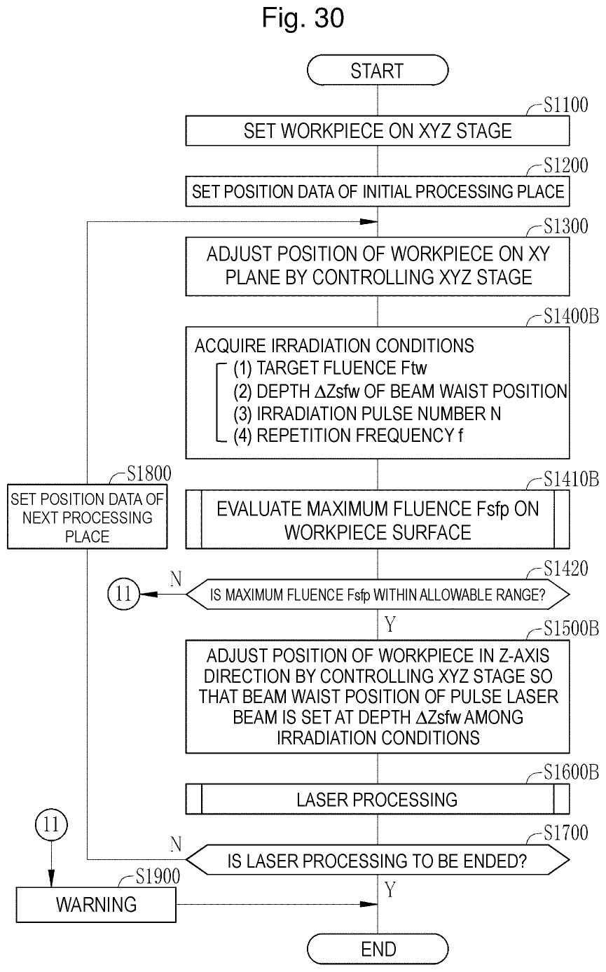

The following describes an operation of the laser processing system 2B with reference to FIGS. 30 to 32. The flowchart of FIG. 30 of the second embodiment is different from the flowchart of FIG. 23 of the first embodiment in that step S1400 is replaced with step S1400B, step S1410 is replaced with S1410B, and S1500 and S1600 are replaced with S1500B and S1600B, respectively. The other features are same. The laser processing control unit 32B executes S1400B after S1100 to S1300.

At S1400B, the laser processing control unit 32B acquires the irradiation conditions of the pulse laser beam. At S1400B, the irradiation conditions include the target fluence Ftw at the beam waist position BW, a depth ΔZfsw of the beam waist position BW, the irradiation pulse number N, and the repetition frequency f.

S1410B is processing of evaluating the maximum fluence Fsfp at the surface 41a of the workpiece 41. S1420 is processing of determining whether the maximum fluence Fsfp is within the allowable range based on a result of the evaluation at S1410B. When the maximum fluence Fsfp is determined to be within the allowable range at S1420 (Y at S1420), the laser processing control unit 32B proceeds to S1500B. Thereafter, the laser processing control unit 32B executes processing at S1600B. The subsequent processing in the main flowchart is same as that in the first embodiment.

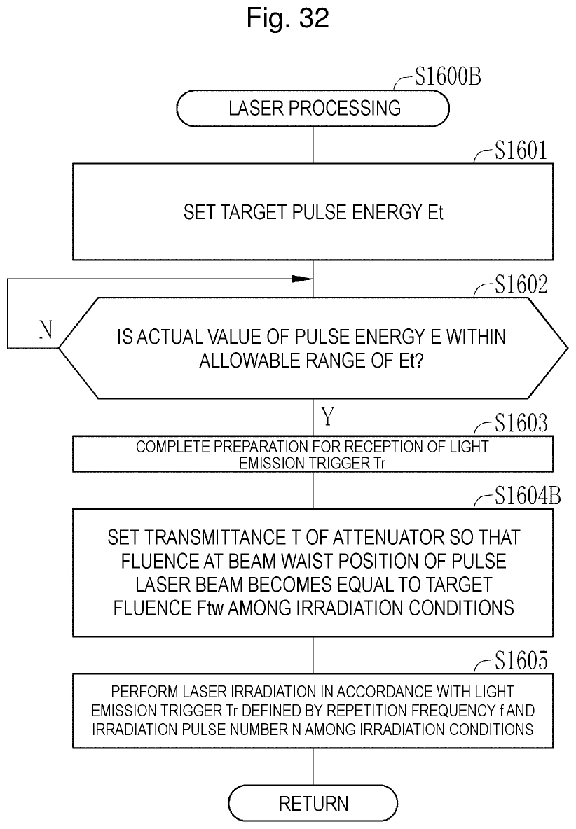

FIG. 32 is a flowchart illustrating the procedure of evaluation processing of the maximum fluence Fsfp at S1410B. FIG. 32 is different from FIG. 24 of the first embodiment in that S1411 to S1413 are replaced with S1411B to S1413B. At S1411B, the laser processing control unit 32B reads the value of the depth ΔZsfw from the data of the irradiation conditions and sets the read ΔZsfw as the distance ZLw. At S1412B, the laser processing control unit 32B reads the light intensity ratio Rw corresponding to the irradiation conditions from the correlation data of the distance ZLw and the light intensity ratio Rw, which is illustrated in FIG. 29. Specifically, the laser processing control unit 32B reads the light intensity ratio Rw corresponding to the distance ZLw to which the value of the depth ΔZsfw is set at S1411B (S1412B).

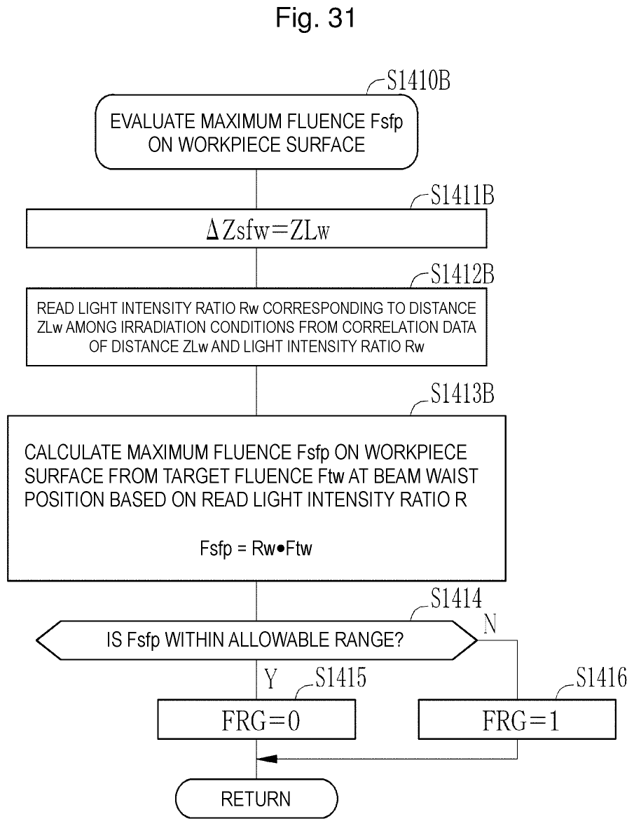

Based on the read light intensity ratio Rw, the laser processing control unit 32B calculates the maximum fluence Fsfp at the surface 41a of the workpiece 41 from the target fluence Ftw at the beam waist position BW by Expression (9) described above (S1413B). The subsequent processing in the subroutine in FIG. 31 is same as that in the first embodiment.

FIG. 32 illustrates the processing procedure of the laser processing at S1600B. FIG. 32 is different from FIG. 4 of the comparative example in that S1604 is replaced with S1604B. At S1604B, the laser processing control unit 32B sets the transmittance T of the attenuator 52 so that the fluence Fw at the beam waist position BW of the pulse laser beam PL becomes equal to the target fluence Ftw among the irradiation conditions. The other processing is same as that in FIG. 4.

5.3 Effect

Similarly to the first embodiment, when the maximum fluence Fsfp is determined to be within the allowable range, the laser processing system 2B of the second embodiment allows irradiation with the pulse laser beam. Thus, generation of the crack CR can be reduced. In addition, in the second embodiment in which the condensation optical system is used, the use efficiency of the pulse laser beam PL is higher than in the first embodiment in which the transfer lens 48 is used. Thus, in the second embodiment, when a hole having the same size is to be processed in the same material, the pulse energy of the pulse laser beam PL output from the laser apparatus 3 can be reduced as compared to the first embodiment. In the second embodiment, the other effects and preferable processing conditions are same as those in the first embodiment.

5.4 Other

The resonator of the laser apparatus 3 is a Fabry-Perot resonator and may be an unstable resonator. In the unstable resonator, the output coupling mirror 27 has a partial reflection surface formed as a convex surface, and the rear mirror 26 has a high reflection surface formed as a concave surface. When such an unstable resonator is employed, the diameter Dw at the beam waist position BW of the pulse laser beam PL can be reduced, and the fluence at the beam waist position BW can be increased.

6. Laser Processing System and Laser Processing Method of Third Embodiment

6.1 Configuration

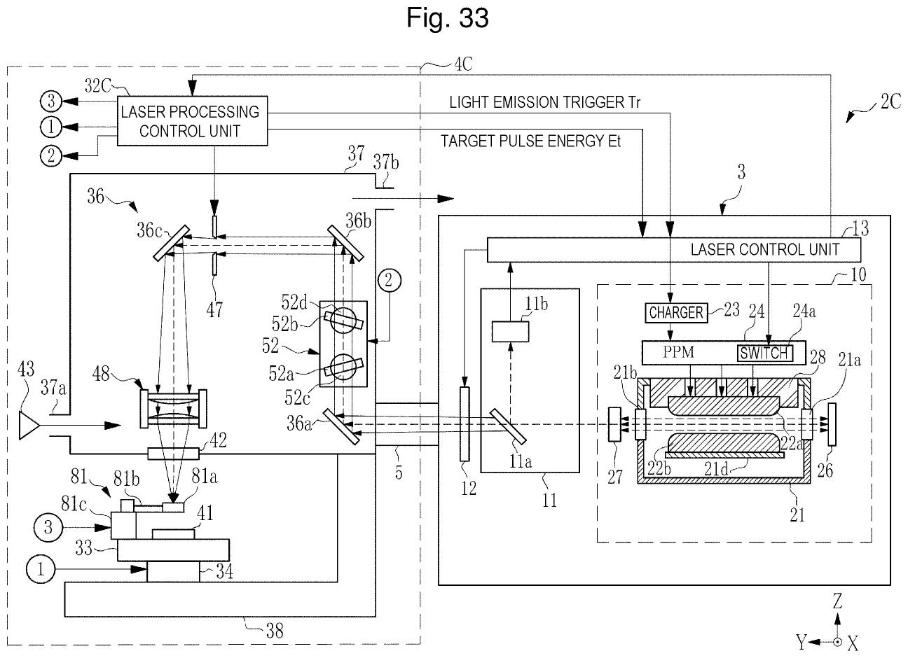

FIG. 33 illustrates a laser processing system 2C of a third embodiment. As illustrated in FIG. 33, the laser processing system 2C of the third embodiment includes the laser apparatus 3 and a laser processing device 4C. The laser apparatus 3 is same as that of the first embodiment. The laser processing device 4C includes a beam profiler 81 in addition to the configuration of the laser processing device 4A of the first embodiment.

In addition, the laser processing device 4C includes a laser processing control unit 32C in place of the laser processing control unit 32A of the laser processing device 4A. The laser processing control unit 32C has, in addition to the function of the laser processing control unit 32A, a function to control the beam profiler 81 to acquire data indicating the correlation between the distance ZL and the light intensity ratio R, which is illustrated in FIG. 14. In the third embodiment, the other features are same as those in the first embodiment. The following description will be mainly made on the difference.

As illustrated in FIG. 33, the beam profiler 81 is provided at an end part of a table 33. The beam profiler 81 includes the image sensor 81a, a bracket 81b, and a one-axis stage 81c. One end of the bracket 81b is attached to the image sensor 81a, and the other end is attached to the one-axis stage 81c.

The one-axis stage 81c moves the image sensor 81a in the Y-axis direction. Specifically, the one-axis stage 81c moves the image sensor 81a between an insertion position where the image sensor 81a is inserted at a position on the optical axis of the pulse laser beam PL emitted from the transfer lens 48 and a retraction position to which the image sensor 81a is retracted from the insertion position. At the retraction position, the image sensor 81a does not interfere with the laser processing performed on the workpiece 41 on the table 33. The position of the image sensor 81a in the Z-axis direction can be adjusted by the XYZ stage 34. Although not illustrated, the beam profiler 81 is provided with an ND filter (not illustrated). The ND filter dims the pulse laser beam incident on a light receiving surface of the image sensor 81a.

6.2 Operation

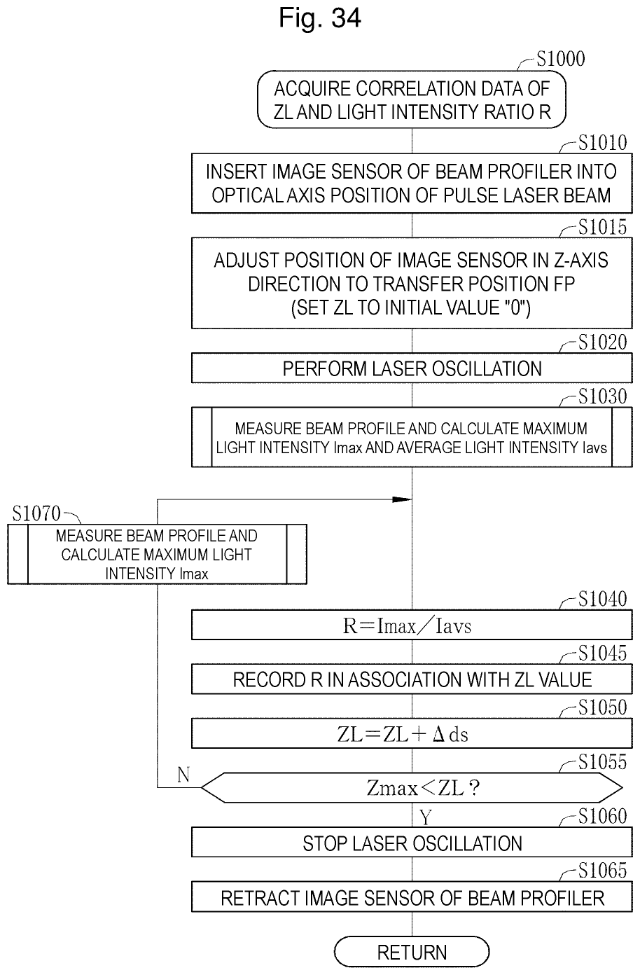

A laser processing procedure of the third embodiment is substantially same as that illustrated in FIGS. 23 and 24 in the first embodiment. The difference therebetween is such that processing at S1000 illustrated in FIG. 34 is added before S1100 in the flowchart of FIG. 23.

S1000 illustrated in FIG. 34 is processing of acquiring the correlation data of the distance ZL and the light intensity ratio R. As illustrated in the flowchart of FIG. 34, at S1010, the laser processing control unit 32C controls the one-axis stage 81c to insert the image sensor 81a of the beam profiler 81 at a position on the optical axis of the pulse laser beam PL.

At S1015, the laser processing control unit 32C controls the XYZ stage 34 to adjust the position of the image sensor 81a in the Z-axis direction to the transfer position FP of the pulse laser beam. At this position, the distance ZL matches with the light receiving surface of the image sensor 81a. Thus, the laser processing control unit 32C sets an initial value “0” to the value of the distance ZL on the memory.

Then, the laser processing control unit 32C causes the laser apparatus 3 to perform laser oscillation by transmitting a control signal for laser oscillation under typical conditions to the laser control unit 13 (S1020). The typical conditions are, for example, rated values of the laser apparatus 3. As specific values, for example, the target pulse energy Et is 40 mJ to 200 mJ, and the repetition frequency f is 10 Hz to 6 kHz. When the processing conditions of the laser processing are known at this timing, the target pulse energy Et and the repetition frequency f defined as the processing conditions may be set to perform laser oscillation.

At S1030, the laser processing control unit 32C outputs the pulse laser beam PL from the laser apparatus 3 and receives the pulse laser beam PL at the image sensor 81a, thereby measuring the beam profile. The laser processing control unit 32C calculates the maximum light intensity Imax and the average light intensity Iavs of the pulse laser beam based on the measured beam profile. Then, the laser processing control unit 32C calculates the light intensity ratio R=Imax/Iavs in accordance with Expression (4) (S1040). The laser processing control unit 32C records the calculated value of the light intensity ratio R in the memory in association with the value of the distance ZL (S1045).

Having ended the recording of the light intensity ratio R, the laser processing control unit 32C moves upward the position of the image sensor 81a in the Z-axis direction by Δds (S1050). Along with this, the laser processing control unit 32C adds Δds to the value of the distance ZL on the memory. The value Δds is the interval of movement of the image sensor 81a in the Z-axis direction. Accordingly, the laser processing control unit 32C measures the light intensity ratio R at the interval Δds. The value of Δds is, for example, 100 μm.

At S1055, the laser processing control unit 32C determines whether the distance ZL has exceeded an upper limit value Zmax. The upper limit value Zmax is, for example, 1.5 mm. When the distance ZL is equal to or smaller than the upper limit value Zmax (N at S1055), the laser processing control unit 32C proceeds to S1070. S1070 is processing of measuring the beam profile at the distance ZL set at S1050 and calculating the maximum light intensity Imax.

After having ended the processing at S1070, the laser processing control unit 32C repeats the above-described processing at S1040 to S1050. Accordingly, data of the light intensity ratio R is recorded at the interval Δds. When the distance ZL has exceeded the upper limit value Zmax (Y at S1055), the laser processing control unit 32C ends the measurement and stops the laser oscillation (S1060). Then, the laser processing control unit 32C moves the image sensor 81a of the beam profiler 81 to the retraction position (S1065). The laser processing control unit 32C generates correlation data of the distance ZL and the light intensity ratio R as illustrated in FIG. 14 based on the data of the light intensity ratio R recorded at the interval Δds.

The laser processing control unit 32C stores the generated correlation data in the memory or an external storage. The correlation data may be recorded in a table format, or an approximate expression may be calculated from a plurality of pieces of the data of the light intensity ratio R recorded at each Δds and may be recorded in a function format. Data interpolation may be performed based on the pieces of the data of the light intensity ratio R recorded at each Δds. After having acquired the correlation data in this manner, the laser processing control unit 32C proceeds to S1100 in FIG. 23. The subsequent processing is same as that in the first embodiment.

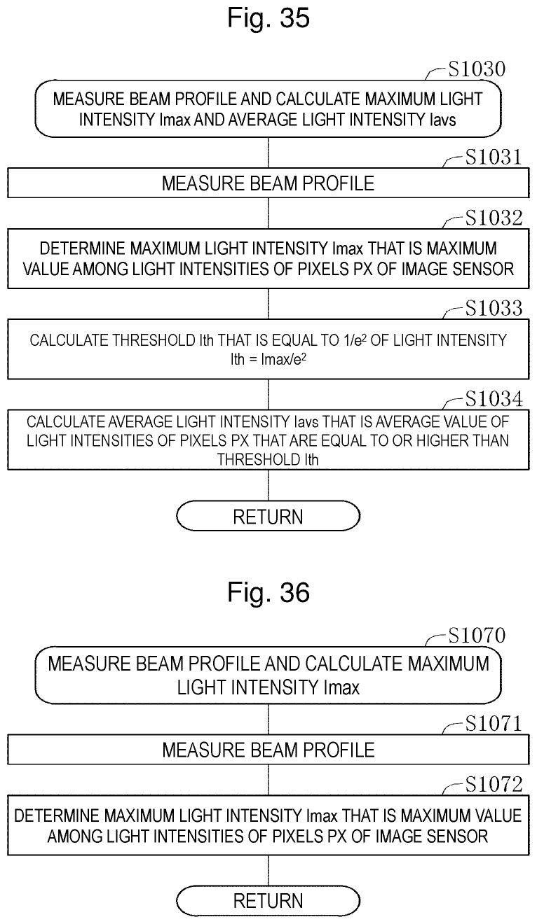

The flowchart of FIG. 35 illustrates the procedure of calculation processing of the maximum light intensity Imax and the average light intensity Iavs at S1030. The content of the processing at S1030 is same as that schematically described with reference to FIGS. 8 to 10. At S1030, the average light intensity Iavs at the transfer position FP and the maximum light intensity Imax at the transfer position FP are calculated.

First, the laser processing control unit 32C performs measurement of the beam profile by the image sensor 81a (S1031). Subsequently, the laser processing control unit 32C calculates the maximum light intensity Imax as the maximum value among the light intensities I of the pixels PX of the image sensor 81a (S1032). Subsequently, the laser processing control unit 32C calculates, in accordance with Expression (10) below, the threshold Ith as a light intensity indicating 1/e² of the maximum light intensity Imax (S1033).

Ith=Imax/e² (10)

Lastly, the laser processing control unit 32C calculates the average light intensity Iavs as an average value of the light intensities I over pixels PX for which the light intensity I is equal to or larger than the threshold Ith (S1034).

The flowchart of FIG. 36 illustrates the procedure of calculation processing of the maximum light intensity Imax at S1070. In the processing at S1070, unlike the processing at S1030 illustrated in FIG. 35, the average light intensity is not calculated but the maximum light intensity Imax at the position of the distance ZL after movement from the transfer position FP is calculated.

Thus, the processing at S1070 is same as that at the steps in the first half of FIG. 35 without the steps of calculating the average light intensity in the second half. Accordingly, first at 51071, the laser processing control unit 32C measures the beam profile by the image sensor 81a. Subsequently, the laser processing control unit 32C calculates the maximum light intensity Imax as the maximum value among the light intensities I of the pixels PX of the image sensor 81a (S1072).

6.3 Effect

In the third embodiment, the correlation data of the distance ZL and the light intensity ratio R is measured by using the beam profiler 81 before the laser processing. Thus, the correlation data on which individual variability of the laser processing system 2C, such as characteristics of the optical system 36, is reflected can be acquired. Accordingly, the accuracy of calculation of the maximum fluence Fsfp improves.

6.4 Other

In the present example, the pulse laser beam incident on the image sensor 81a is dimmed by the ND filter. However, when the ND filter is used but the amount of light dimming is insufficient and an output signal from the image sensor 81a is saturated, the transmittance T of the attenuator 52 may be controlled to reduce the energy of the pulse laser beam incident on the image sensor 81a. However, the transmittance T of the attenuator 52 is fixed while the correlation data is acquired. This is because the correlation data cannot be accurately acquired when the transmittance T varies halfway through the acquisition.

7. Modifications of Laser Processing Device

7.1 Modification 7-1

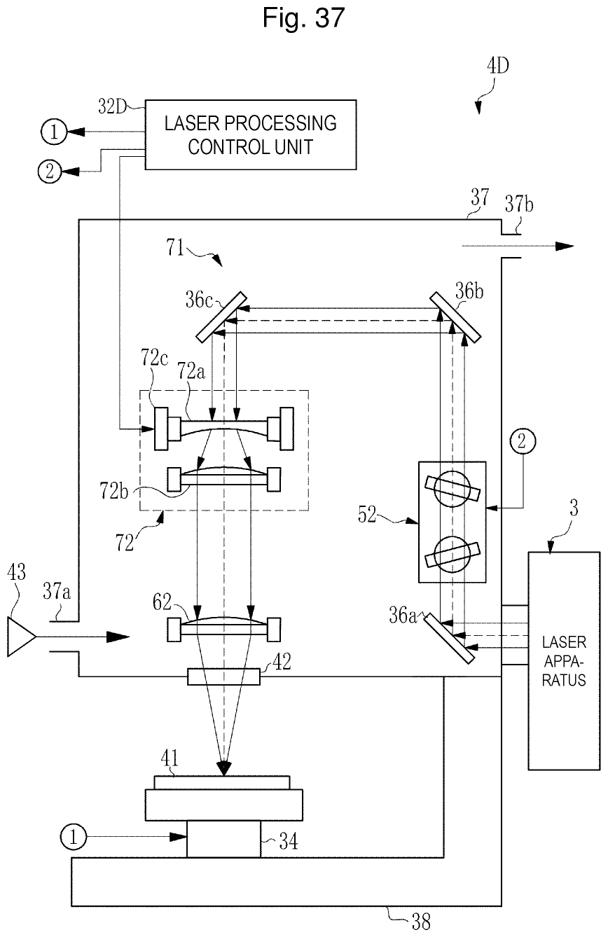

A laser processing device 4D illustrated in FIG. 37 is a modification of the laser processing device 4B of the second embodiment illustrated in FIG. 26. The laser processing device 4D includes an optical system 71 in place of the optical system 61 of the laser processing device 4B. The laser processing device 4D further includes a laser processing control unit 32D in place of the laser processing control unit 32B. The other configuration is same. The following description will be mainly made on any difference.

The optical system 71 includes a wavefront adjuster 72 in addition to the configuration of the optical system 61. The wavefront adjuster 72 includes a concave lens 72a, a convex lens 72b, and a one-axis stage 72c. The one-axis stage 72c holds the concave lens 72a and moves the concave lens 72a in the optical axis direction to adjust the interval between the concave lens 72a and the convex lens 72b. The concave lens 72a and the convex lens 72b are disposed on the optical path of the pulse laser beam between the high reflectance mirror 36c and the light condensation lens 62. The pulse laser beam reflected at the high reflectance mirror 36c is incident on the light condensation lens 62 through the concave lens 72a and the convex lens 72b.

The beam waist position BW of the pulse laser beam incident on the workpiece 41 can be changed by adjusting the interval between the concave lens 72a and the convex lens 72b.

The laser processing control unit 32D adjusts the position of the workpiece 41 on the XY plane by controlling the XYZ stage 34. As for the relative positions of the beam waist position BW of the pulse laser beam and the workpiece 41 in the Z-axis direction, the beam waist position in the Z-axis direction is adjusted by controlling the one-axis stage 72c of the wavefront adjuster 72 instead of moving the workpiece 41 by the XYZ stage 34. Specifically, the laser processing control unit 32D changes the wavefront of the pulse laser beam by controlling the one-axis stage 72c to adjust the interval between the concave lens 72a and the convex lens 72b. The beam waist position BW of the pulse laser beam is adjusted through the control of the wavefront of the pulse laser beam.

7.2 Modification 7-2

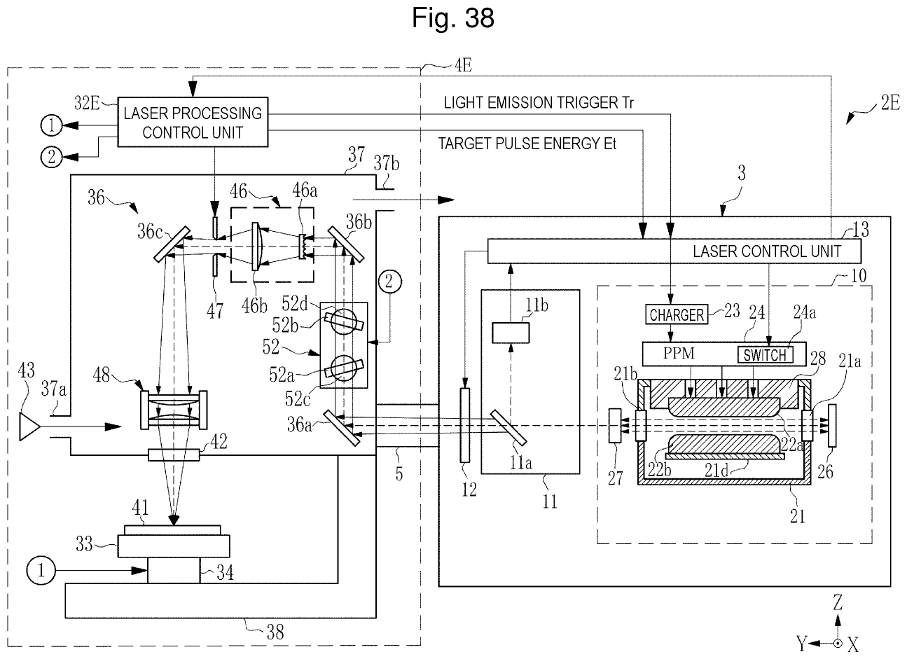

In a laser processing system 2E illustrated in FIG. 38, the laser processing device 4A of the laser processing system 2A of the first embodiment is replaced with a laser processing device 4E. The laser processing device 4E includes a beam homogenizer 46. The beam homogenizer 46 is disposed upstream of the transfer mask 47 in the optical axis direction of the pulse laser beam. The beam homogenizer 46 includes a fly-eye lens 46a and a condenser lens 46b. The beam homogenizer 46 is disposed to homogenize the light intensity distribution of the pulse laser beam reflected at the high reflectance mirror 36b and perform Koehler illumination of the transfer mask 47. The laser processing device 4E includes a laser processing control unit 32E in place of the laser processing control unit 32A. The other configuration is same as that in the first embodiment.

The fly-eye lens 46a of the beam homogenizer 46 has a configuration in which a plurality of small lenses are two-dimensionally arrayed. Thus, a plurality of peaks corresponding to the respective small lenses are sometimes generated in the beam profile of the beam section SP upstream of the transfer position FP at which the transfer image is formed. In this case as well, one top-hat shape is formed at the transfer position FP.

However, when the transfer position FP is at the inside from the surface 41a of the workpiece 41, the beam section SP in which a plurality of peaks are generated is closer to the surface 41a upstream of the transfer position FP in some cases. In such a case, a plurality of fluence peaks exist in the beam section SP at the surface 41a. When a plurality of fluence peaks at the surface 41a exist, the laser processing control unit 32E determines the maximum fluence Fsfp to be a peak having the maximum value among the peaks. Then, the laser processing control unit 32E determines whether the maximum fluence Fsfp is within the allowable range. The other processing is same as that in the first embodiment.

When the beam homogenizer 46 is used as in the present example, the transfer mask 47 is irradiated with the pulse laser beam having a homogenized light intensity, and accordingly, the light intensity distribution at the transfer position FP is homogenized.

The transfer mask 47 may be provided with a plurality of holes. In this case, a plurality of holes can be simultaneously processed in the workpiece 41.

8. Modifications of Laser Apparatus

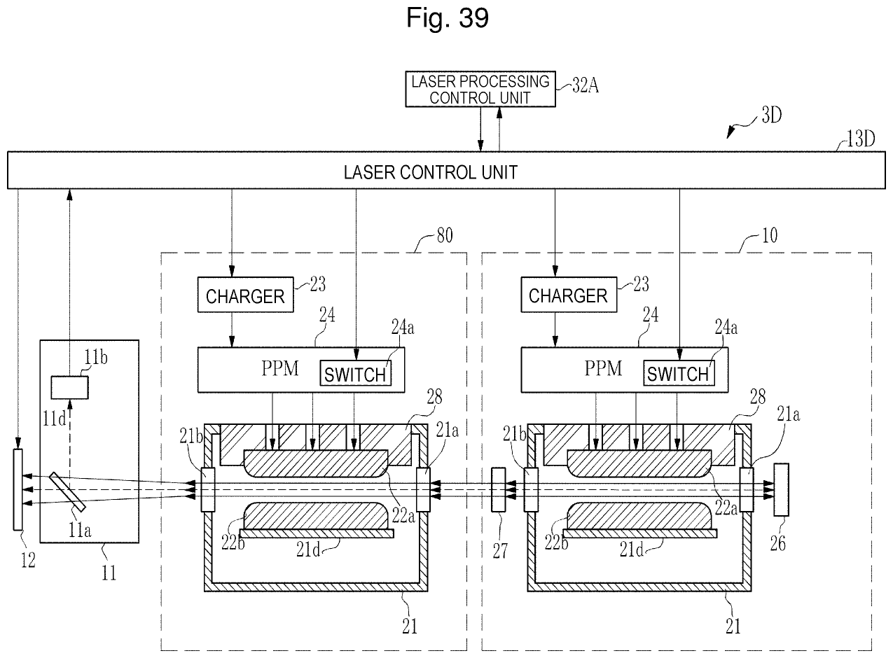

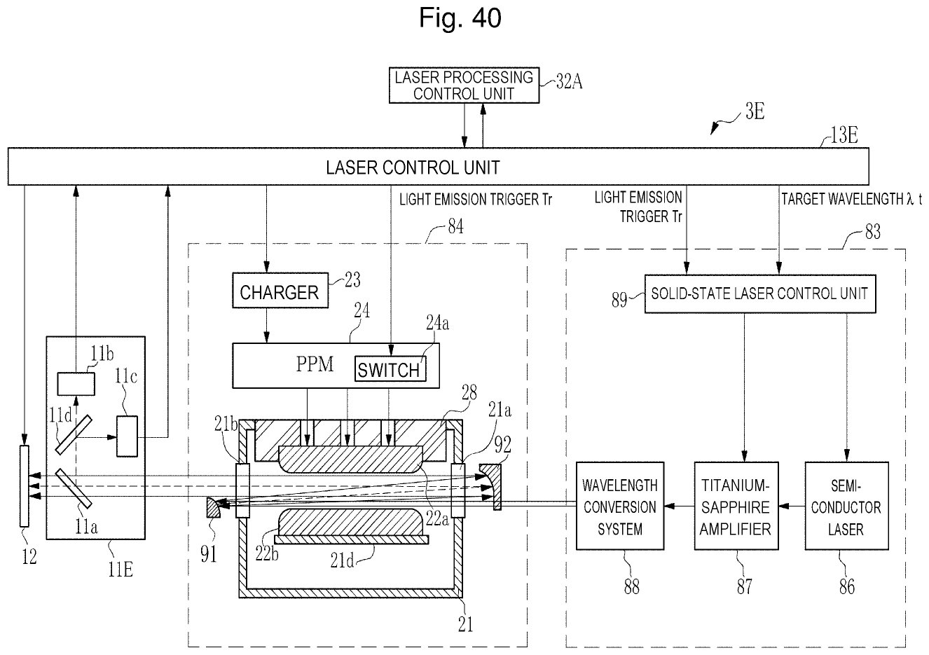

In each above-described embodiment, the laser apparatus may be modified in various kinds of manners. For example, for the laser apparatus, laser apparatuses illustrated in FIGS. 39 and 40 may be used.

8.1 Modification 8-1

A laser apparatus 3D of Modification 8-1 illustrated in FIG. 39 includes an amplifier 80 in addition to the configuration of the laser apparatus 3 of the first embodiment, and the other configuration is substantially same as that of the first embodiment. The amplifier 80 is disposed on the optical path of the pulse laser beam between the master oscillator 10 and the monitor module 11. The amplifier 80 amplifies the energy of the pulse laser beam output from the master oscillator 10.

The amplifier 80 has a basic configuration same as that of the master oscillator 10 and includes the laser chamber 21, the charger 23, and the pulse power module (PPM) 24, similarly to the master oscillator 10.

When having received data of the target pulse energy Et from the laser processing control unit 32A, a laser control unit 13D controls the pulse energy by controlling the charge voltage of the charger 23.

When having received the light emission trigger Tr from the laser processing control unit 32A, the laser control unit 13D causes the master oscillator 10 to perform laser oscillation. In addition, the laser control unit 13D controls the amplifier 80 to actuate in synchronization with the master oscillator 10. The laser control unit 13D turns on the switch 24a of the pulse power module 24 of the amplifier 80 so that electric discharge occurs when the pulse laser beam output from the master oscillator 10 is incident in an electric discharge space in the laser chamber 21 of the amplifier 80. As a result, the pulse laser beam incident on the amplifier 80 performs amplified oscillation at the amplifier 80.

The pulse energy of the pulse laser beam amplified and output by the amplifier 80 is measured at the monitor module 11. The laser control unit 13D controls the charge voltage of the charger 23 of each of the amplifier 80 and the master oscillator 10 so that the measured actual value of the pulse energy becomes closer to the target pulse energy Et.

When the shutter 12 is opened, the pulse laser beam having passed through the beam splitter 11a of the monitor module 11 is incident on the laser processing device 4A illustrated in FIG. 22.

The pulse energy of the pulse laser beam can be increased when the amplifier 80 is provided as in the laser apparatus 3D.

8.2 Modification 8-2

In the laser processing system, a laser apparatus 3E of Modification 8-2 illustrated in FIG. 40 may be used. The laser apparatus 3E includes a master oscillator 83 and an amplifier 84. The laser apparatus 3E further includes a monitor module 11E in place of the monitor module 11.

The monitor module 11E includes a wavelength monitor 11c and a beam splitter 11d in addition to the configuration of the monitor module 11 of the first embodiment.

In the monitor module 11E, the beam splitter 11d is disposed between the beam splitter 11a and the optical sensor lib on the reflected light path of the beam splitter 11a. The beam splitter 11d reflects part of light reflected by the beam splitter 11a, and transmits the remaining part. The light having passed through the beam splitter 11d is incident on the optical sensor lib, and the light reflected by the beam splitter 11d is incident on the wavelength monitor 11c.

The wavelength monitor 11c is a publicly known etalon spectrometer. The etalon spectrometer includes, for example, a diffusion plate, an air gap etalon, a light condensation lens, and a line sensor. The etalon spectrometer generates an interference fringe of an incident laser beam through the diffusion plate and the air gap etalon, and images the generated interference fringe on a light receiving surface of the line sensor through the light condensation lens. Then, the interference fringe imaged on the line sensor is measured to measure the wavelength λ of the laser beam.

The master oscillator 83 is a solid-state laser apparatus including a semiconductor laser 86 configured to output a seed beam, a titanium-sapphire amplifier 87 configured to amplify the seed beam, and a wavelength conversion system 88.

The semiconductor laser 86 is a distributed-feedback semiconductor laser configured to output, as the seed beam, a continuous wave (CW) laser beam that is a continuously oscillating laser beam having a wavelength of 773.6 nm. The oscillation wavelength can be changed by changing temperature setting of the semiconductor laser 86.

The titanium-sapphire amplifier 87 includes a titanium-sapphire crystal (not illustrated) and a pumping pulse laser device (not illustrated). The titanium-sapphire crystal is disposed on the optical path of the seed beam. The pumping pulse laser device outputs the second harmonic light of a YLF laser.

The wavelength conversion system 88 generates the fourth harmonic light and includes an LBO (LiB₃O₅) crystal and a KBBF (KBe₂BO₃F₂) crystal. Each crystal is disposed on a rotation stage (not illustrated) so that the incident angle of the seed beam on the crystal can be changed.

Similarly to the amplifier 80 illustrated in FIG. 39, the amplifier 84 includes the pair of electrodes 22a and 22b, the laser chamber 21 containing ArF laser gas as a laser medium, the pulse power module 24, and the charger 23. The amplifier 84 includes a convex mirror 91 and a concave mirror 92.

The convex mirror 91 and the concave mirror 92 are disposed so that the pulse laser beam output from the master oscillator 83 is enlarged while passing through the electric discharge space of the laser chamber 21 three times through reflection at the convex mirror 91 and the concave mirror 92.

When having received a target wavelength λt and the target pulse energy Et from the laser processing control unit 32A, a laser control unit 13E transmits the target wavelength λt to a solid-state laser control unit 89 of the master oscillator 83. In addition, the laser control unit 13E sets the charge voltage of the charger 23 of the amplifier 84 so that the target pulse energy Et is achieved.

When having received the target wavelength λt from the laser control unit 13E, the solid-state laser control unit 89 changes an oscillation wavelength λa1 of the semiconductor laser 86 so that the wavelength of the seed beam output from the wavelength conversion system 88 becomes equal to the target wavelength λt. The oscillation wavelength λa1 is set to be four times longer than the target wavelength λt, that is, λa1=4λt. Since the target wavelength λt is 193.4 nm, λa1 is 193.4×4=773.6 nm. The amplification by the amplifier 84 using ArF laser gas as a laser medium is possible in a wavelength range of 193.2 nm to 193.6 nm, and thus the target wavelength λt may be changed in the wavelength range as necessary.

The solid-state laser control unit 89 controls the rotation stages (not illustrated) to set the incident angles of the laser beam on the LBO crystal and the KBBF crystal so that the wavelength conversion efficiencies of the crystals are maximum in the wavelength conversion system 88.

When having received the light emission trigger Tr from the laser control unit 13E, the solid-state laser control unit 89 transmits a trigger signal to a pumping pulse laser apparatus of the titanium-sapphire amplifier 87. In the titanium-sapphire amplifier 87, the pumping pulse laser apparatus converts a CW laser beam as the input seed beam into a pulse laser beam based on the trigger signal, and outputs the pulse laser beam. The pulse laser beam output from the titanium-sapphire amplifier 87 is input to the wavelength conversion system 88. The wavelength conversion system 88 performs wavelength conversion of the pulse laser beam at λa1 into a pulse laser beam at the target wavelength λt as the fourth harmonic, and outputs the converted pulse laser beam.

When having received the light emission trigger Tr from the laser processing control unit 32A, the laser control unit 13E turns on the switch 24a of the pulse power module 24 so that electric discharge occurs when the pulse laser beam output from the master oscillator 83 is incident in the electric discharge space of the laser chamber 21 of the amplifier 84.

As a result, the pulse laser beam incident on the amplifier 84 from the master oscillator 83 is amplified in the laser chamber 21 while passing through the electric discharge space three times by the effects of the convex mirror 91 and the concave mirror 92. In addition, the beam diameter of the pulse laser beam is increased through the three-time passing.

The amplified pulse laser beam is sampled by the monitor module 11E to measure the actual values of the pulse energy and the wavelength. The laser control unit 13E controls the charge voltage of the charger 23 so that the difference between the measured pulse energy and the measured target pulse energy Et becomes closer to zero. In addition, the laser control unit 13E controls the oscillation wavelength λa1 of the semiconductor laser 86 so that the difference between the measured wavelength and the target wavelength λt becomes closer to zero. The pulse laser beam having passed through the beam splitter 11a of the monitor module 11E is incident on the laser processing device when the shutter 12 is opened.

When the master oscillator 83 is a solid-state laser apparatus, the master oscillator 83 is preferably applied as a light source of the laser processing device 4B illustrated in FIG. 26 or laser processing device 4D illustrated in FIG. 37. A pulse laser beam output from the master oscillator 83 is similar to a Gaussian beam in a single transverse mode, and thus the beam diameter at the beam waist position BW can be decreased close to diffraction limit.

In the present example, the amplifier 84 is a multipass amplifier but not limited thereto. For example, the amplifier 84 may be an amplifier including a Fabry-Perot resonator or a ring resonator.

In the present example, the master oscillator 83 is a solid-state laser apparatus, and the laser apparatus 3E is composed of a combination of the solid-state laser apparatus and the amplifier 84 that uses ArF laser gas as a laser medium.

When the amplifier 84 uses KrF laser gas as a laser medium, amplification is possible in a wavelength range of 248.1 nm to 248.7 nm. A laser apparatus in this case may be a wavelength-variable solid-state laser apparatus in which the master oscillator 83 can change wavelength in the wavelength range in which amplification is possible, or may be a line narrowing KrF excimer laser apparatus capable of narrowing of the spectral width. When the amplifier 84 uses F₂ laser gas as a laser medium, amplification is possible at a wavelength of 157.6 nm. A laser apparatus in this case is, for example, a solid-state laser apparatus in which the master oscillator 83 oscillates in this wavelength band. As described above, the wavelength of an ultraviolet pulse laser beam is preferably 157.6 nm to 248.7 nm for an amplifier configured to amplify the ultraviolet pulse laser beam.

The description above is intended to be illustrative and the present disclosure is not limited thereto. Therefore, it would be obvious to those skilled in the art that various modifications to the embodiments of the present disclosure would be possible without departing from the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.

What is claimed is:

1. A laser processing method of performing laser processing on a transparent material that is transparent to ultraviolet light by using a laser processing system including a laser apparatus configured to output a pulse laser beam that is the ultraviolet light, a transfer mask provided with a transfer pattern through which the pulse laser beam passes, and a transfer optical system configured to transfer a transfer image formed when the pulse laser beam passes through the transfer pattern and having a shape in accordance with the transfer pattern, the laser processing method comprising:
A. a positioning step of performing relative positioning of a transfer position of the transfer image transferred by the transfer optical system and the transparent material in an optical axis direction of the pulse laser beam so that the transfer position is set at a position inside the transparent material at a predetermined depth ΔZsf from a surface of the transparent material in the optical axis direction;
B. an irradiation condition acquisition step of acquiring irradiation conditions including a target fluence of the pulse laser beam at the transfer position and the depth ΔZsf;
C. a determination step of determining whether a maximum fluence of the pulse laser beam at the surface of the transparent material is within a predetermined range based on the irradiation conditions; and
D. a control step of allowing irradiation with the pulse laser beam when the maximum fluence is determined to be in the predetermined range,
the target fluence being an average fluence in a beam section in a direction orthogonal to an optical axis of the pulse laser beam at the transfer position, the maximum fluence being a maximum value among fluences of a plurality of small regions obtained by dividing the beam section on the surface of the transparent material.

2. The laser processing method according to claim 1, further comprising: E. a warning step of performing warning when the maximum fluence is determined to be out of the predetermined range at the determination step.

3. The laser processing method according to claim 1, wherein the pulse laser beam has a pulse width of 1 ns to 100 ns and has a beam diameter of 10 μm to 150 μm inclusive at the transfer position.

4. The laser processing method according to claim 1, wherein the transparent material is synthetic quartz glass, and the pulse laser beam has a wavelength of 157.6 nm to 248.7 nm.

5. The laser processing method according to claim 4, wherein the pulse laser beam is an ArF laser beam.

6. The laser processing method according to claim 5, wherein the depth ΔZsf is within a range from 0 mm to 4 mm inclusive.

7. The laser processing method according to claim 6, wherein the maximum fluence is 10 J/cm² to 40 J/cm² inclusive.

8. The laser processing method according to claim 7, wherein the target fluence of the pulse laser beam at the transfer position is 5 J/cm² to 30 J/cm² inclusive.

9. The laser processing method according to claim 5, wherein a number of irradiation pulses of the pulse laser beam is 5,000 or larger.

10. The laser processing method according to claim 9, wherein the number of irradiation pulses is 20,000 or smaller.

11. A laser processing method of performing laser processing on a transparent material that is transparent to ultraviolet light by using a laser processing system including a laser apparatus configured to output a pulse laser beam that is the ultraviolet light and a condensation optical system configured to condense the pulse laser beam, the laser processing method comprising:
A. a positioning step of performing relative positioning of a beam waist position of the pulse laser beam and the transparent material in an optical axis direction of the pulse laser beam so that the beam waist position is set at a position inside the transparent material at a predetermined depth ΔZsfw from a surface of the transparent material in the optical axis direction;
B. an irradiation condition acquisition step of acquiring irradiation conditions including a target fluence of the pulse laser beam at the beam waist position and the depth ΔZsf;
C. a determination step of determining whether a maximum fluence of the pulse laser beam at the surface of the transparent material is within a predetermined range based on the irradiation conditions; and
D. a control step of allowing irradiation with the pulse laser beam when the maximum fluence is determined to be in the predetermined range,
the target fluence being an average fluence in a beam section in a direction orthogonal to an optical axis of the pulse laser beam at the beam waist position, the maximum fluence being a maximum value among fluences of a plurality of small regions obtained by dividing the beam section on the surface of the transparent material.

12. The laser processing method according to claim 11, further comprising: E. a warning step of performing warning when the maximum fluence is determined to be out of the predetermined range at the determination step.

13. The laser processing method according to claim 11, wherein the pulse laser beam has a pulse width of 1 ns to 100 ns and has a beam diameter of 10 μm to 150 μm inclusive at the beam waist position.

14. The laser processing method according to claim 11, wherein the transparent material is synthetic quartz glass, and the pulse laser beam has a wavelength of 157.6 nm to 248.7 nm.

15. The laser processing method according to claim 14, wherein the pulse laser beam is an ArF laser beam.

16. The laser processing method according to claim 15, wherein the depth ΔZsf is within a range from 0 mm to 4 mm inclusive.

17. The laser processing method according to claim 16, wherein the maximum fluence is 10 J/cm² to 40 J/cm² inclusive.

18. The laser processing method according to claim 17, wherein the target fluence of the pulse laser beam at the beam waist position is 5 J/cm² to 30 J/cm² inclusive.

19. The laser processing method according to claim 18, wherein a number of irradiation pulses of the pulse laser beam is 5,000 or larger.

20. A laser processing system configured to perform laser processing by irradiating a transparent material that is transparent to ultraviolet light with a pulse laser beam that is the ultraviolet light, the laser processing system comprising:
A. a laser apparatus configured to output a pulse laser beam;
B. a transfer mask provided with a transfer pattern through which the pulse laser beam output from the laser apparatus passes;
C. a transfer optical system configured to transfer, onto the transparent material, a transfer image formed when the pulse laser beam passes through the transfer pattern and having a shape in accordance with the transfer pattern;
D. a positioning mechanism configured to perform relative positioning of a transfer position of the transfer image transferred by the transfer optical system and the transparent material in an optical axis direction of the pulse laser beam so that the transfer position is set at a position inside the transparent material at a predetermined depth ΔZsf from a surface of the transparent material in the optical axis direction;
E. an irradiation condition acquisition unit configured to acquire irradiation conditions including a target fluence of the pulse laser beam at the transfer position and the depth ΔZsf;
F. a determination unit configured to determine whether a maximum fluence of the pulse laser beam at the surface of the transparent material is within a predetermined range based on the irradiation conditions; and
G. a control unit configured to allow irradiation with the pulse laser beam when the maximum fluence is determined to be in the predetermined range,
the target fluence being an average fluence in a beam section in a direction orthogonal to an optical axis of the pulse laser beam at the transfer position, the maximum fluence being a maximum value among fluences of a plurality of small regions obtained by dividing the beam section on the surface of the transparent material.
